(19) United States
(12) Patent Application Publication
(10) Pub. No.: US 2026/0273512 A1
(43) Pub. Date: Sep. 17, 2026

(54) MULTI-METAL CATALYSTS AND METHODS OF MAKING AND USING SAME

(71) Applicants: Tsinghua University, Beijing (CN); Saudi Arabian Oil Company, Dhahran (SA)

(72) Inventors: Chaojie Cui, Beijing (CN); Guijun Liu, Beijing (CN); Weizhong Qian, Beijing (CN); Qingyuan Hu, Dhahran (SA); Ali Shakir Al Hunaidy, Al-Qatif (SA); Ammar Al-Ahmed, Khobar (SA)

(21) Appl. No.: 19/078,976

(22) Filed: Mar. 13, 2025

(51) Int. Cl. B01J 23/80; B01J 35/45; B01J 37/04; B01J 37/08; C10G 2/00

(52) U.S. Cl. CPC B01J 23/80; B01J 35/45; B01J 37/04; B01J 37/08; C10G 2/50; C10G 2400/20

(57) ABSTRACT

Catalysts and methods of hydrogenating carbon dioxide (CO₂) using the catalysts. The catalyst contains Fe; one or more alkali metals selected from the group consisting of sodium (Na) and potassium (K); and one or more metals selected from the group consisting of copper (Cu), zinc (Zn), and magnesium (Mg). A molar ratio of Fe to the one or more metals can be from about 2:1 to 2:3.

### TECHNICAL FIELD

The present disclosure relates to catalysts, more particularly, to multi-metal catalysts. The present disclosure also provides methods of hydrogenating carbon dioxide (CO₂), more particularly, to methods of hydrogenating CO₂ using the multi-metal catalysts.

### BACKGROUND

CO₂ is an abundant and non-toxic carbon source that can be converted into renewable fuels and valuable chemical feedstocks through hydrogenation. This process transforms CO₂ into value-added products such as alcohols, olefins, and other hydrocarbons, offering a sustainable pathway for carbon utilization.

### SUMMARY

In an exemplary embodiment, a catalyst includes iron (Fe), one or more alkali metals selected from the group consisting of sodium (Na) and potassium (K), and one or more metals selected from the group consisting of copper (Cu), zinc (Zn), and magnesium (Mg). In some embodiments, a molar ratio of the Fe to the one or more metals is from about 2:1 to about 2:3.

In some embodiments, the one or more alkali metals are present in the catalyst in an amount of from about 0.1 to about 30 wt. % based on a total weight of the catalyst.

In some embodiments, the catalyst includes particles having a particle size of from about 1 to about 80 nanometers (nm).

In some embodiments, the catalyst includes Fe, Cu, K, and one or more metals selected from the group consisting of Zn and Mg. In some embodiments, a molar ratio of Cu to a total of the Fe and one or more metals is from about 1:2 to about 1:4.

In some embodiments, the catalyst includes Fe, Zn, K, and one or more metals selected from the group consisting of Cu and Mg. In some embodiments, a molar ratio of Zn to a total of the Fe and one or more metals is from about 1:6 to about 1:9.

In some embodiments, the catalyst includes Fe, Mg, K, and one or more metals selected from the group consisting of Cu and Zn. In some embodiments, a molar ratio of Mg to a total of the Fe and one or more metals is from about 1:2 to about 3:10.

In some embodiments, the catalyst is selected from the group consisting of a potassium-copper-iron (K—CuFe) catalyst, a potassium-copper-zinc-iron (K—CuZnFe) catalyst, a potassium-copper-magnesium-iron (K—CuMgFe) catalyst, and a potassium-copper-zinc-magnesium-iron (K—CuZnMgFe) catalyst.

In some embodiments, the catalyst includes from about 5 to about 30 wt. % Fe, from about 6 to about 25 wt. % K, from about 2 to about 20 wt. % Cu, from about 1 to about 10 wt. % Zn, from about 1 to about 10 wt. % Mg, and oxygen (O).

In some embodiments, the catalyst includes from about 13 to about 19 wt. % Fe, from about 10 to about 16 wt. % K, from about 7 to about 13 wt. % Cu, from about 3 to about 7 wt. % Zn, and from about 3 to about 7 wt. % Mg.

In an exemplary embodiment, a method of hydrogenating carbon dioxide (CO₂) includes introducing a hydrogen (H₂)-containing feed gas stream into a reactor containing the catalyst; passing the H₂-containing feed gas stream through the reactor to contact the H₂-containing feed gas stream with the catalyst at a temperature of from about 200 to about 500° C. to form a reduced catalyst; terminating the introducing the H₂-containing feed gas stream; introducing a mixed feed gas stream comprising CO₂ and H₂ into the reactor; and passing the mixed feed gas stream through the reactor to contact the mixed feed gas stream with the reduced catalyst at a temperature of from about 150 to about 250° C. and a pressure of up to 8 megapascals (MPa) to form a gaseous product stream leaving the reactor. In some embodiments, the gaseous product stream comprises a chemical reduction product of the CO₂.

In some embodiments, a volume ratio of the H₂ to CO₂ in the mixed feed gas stream is from about 10:1 to 1:5.

In some embodiments, the H₂-containing feed gas stream is passed through the reactor at a flow rate of from about 10 to about 30 milliliters per minute (mL/min) at a temperature of about 350° C.

In some embodiments, the mixed feed gas stream is passed through the reactor at a flow rate of from about 10 to about 30 mL/min at a temperature of about 200° C. and under a pressure of about 4 MPa.

In some embodiments, the method has a CO₂ conversation rate of about 10 to about 60%.

In some embodiments, the gaseous product stream includes from about 5 to about 25% of carbon monoxide (CO), from about 10 to about 50% of one or more paraffins, from about 0.5 to about 20% of one or more alcohols, and from about 30 to about 80% of one or more olefins, each wt. % based on a total weight of the gaseous product stream.

In some embodiments, the one or more paraffins include C1-C4 light paraffins, the one or more alcohols include methanol and ethanol, and the one or more olefins include C2-C4 light olefins.

In an exemplary embodiment, a method of making a catalyst includes mixing a Fe salt and one or more metal salts selected from the group consisting of a Cu salt, a Zn salt, and a Mg salt to form a mixture; dropwise adding a solution comprising the one or more alkali metals into the mixture at a temperature of from about 50 to about 80° C. under continuous agitation to form a sample comprising a precipitate in the mixture; placing the sample in a water bath at a temperature of from about 60 to about 90° C.; separating the precipitate from the mixture and washing with water to form a precursor product; and calcining the precursor product in an oxygen-containing atmosphere at a temperature of from about 250 to about 500° C. to form the catalyst.

In some embodiments, a total cation concentration of the Fe salt and the one or more metal salts present in the mixture is from about 0.03 to about 0.5 mol/L.

In some embodiments, the one or more alkali metal salts comprise sodium carbonate, sodium acetate, sodium sulfide, sodium bicarbonate, sodium hydroxide, potassium carbonate, potassium acetate, potassium sulfide, potassium bicarbonate, potassium hydroxide, or combinations thereof.

In some embodiments, a pH of the mixture is maintained from about 7 to about 12 by adding the solution comprising the one or more alkali metals.

### BRIEF DESCRIPTION OF THE DRAWINGS

FIG. 1A is a scanning electron microscope (SEM) image of a potassium-copper-iron (K—CuFe) catalyst at 10 micrometers (μm) magnification, according to certain embodiments of the present disclosure.

FIG. 1B is an SEM image of a K—CuFe catalyst at 1 μm magnification, according to certain embodiments of the present disclosure.

FIG. 1C is an SEM image of a K—CuFe catalyst at 1 μm magnification, according to certain embodiments of the present disclosure.

FIG. 2A is an SEM image of a potassium-copper-zinc-iron (K—CuZnFe) catalyst at 10 μm magnification, according to certain embodiments of the present disclosure.

FIG. 2B is an SEM image of a K—CuZnFe catalyst at 1 μm magnification, according to certain embodiments of the present disclosure.

FIG. 2C is an SEM image of a K—CuZnFe catalyst at 1 μm magnification, according to certain embodiments of the present disclosure.

FIG. 3A is an SEM image of a potassium-copper-magnesium-iron (K—CuMgFe) catalyst at 10 μm magnification, according to certain embodiments of the present disclosure.

FIG. 3B is an SEM image of a K—CuMgFe catalyst at 1 μm magnification, according to certain embodiments of the present disclosure.

FIG. 3C is an SEM image of a K—CuMgFe catalyst at 1 μm magnification, according to certain embodiments of the present disclosure.

FIG. 4A is an SEM image of a potassium-copper-zinc-magnesium-iron (K—CuZnMgFe) catalyst at 10 μm magnification, according to certain embodiments of the present disclosure.

FIG. 4B is an SEM image of a K—CuZnMgFe catalyst at 1 μm magnification, according to certain embodiments of the present disclosure.

FIG. 4C is an SEM image of a K—CuZnMgFe catalyst at 1 μm magnification, according to certain embodiments of the present disclosure.

FIG. 5 is a plotted graph illustrating CO₂ hydrogenation results using K—CuFe catalysts, according to certain embodiments of the present disclosure.

FIG. 6 is a plotted graph illustrating CO₂ hydrogenation results using K—CuZnFe catalysts, according to certain embodiments of the present disclosure.

FIG. 7 is a plotted graph illustrating CO₂ hydrogenation results using K—CuMgFe catalysts, according to certain embodiments of the present disclosure.

FIG. 8 is a plotted graph illustrating CO₂ hydrogenation results using K—CuZnMgFe catalysts, according to certain embodiments of the present disclosure.

FIG. 9 illustrates an X-ray diffraction (XRD) analysis of various multi-metal catalysts, according to certain embodiments of the present disclosure.

FIG. 10A is a transmission electron microscope (TEM) image of a K—CuFe catalyst, according to certain embodiments of the present disclosure.

FIG. 10B is a TEM image of a K—CuZnFe catalyst, according to certain embodiments of the present disclosure.

FIG. 10C is a TEM image of a K—CuMgFe catalyst, according to certain embodiments of the present disclosure.

FIG. 10D is a TEM image of a K—CuZnMgFe catalyst, according to certain embodiments of the present disclosure.

FIG. 11A is a plotted graph illustrating a particle size distribution of a K—CuFe catalyst, according to certain embodiments of the present disclosure.

FIG. 11B is a plotted graph illustrating a particle size distribution of a K—CuZnFe catalyst, according to certain embodiments of the present disclosure.

FIG. 11C is a plotted graph illustrating a particle size distribution of a K—CuMgFe catalyst, according to certain embodiments of the present disclosure.

FIG. 11D is a plotted graph illustrating a particle size distribution of a K—CuZnMgFe catalyst, according to certain embodiments of the present disclosure.

FIG. 12 is a schematic process flow chart depicting a method 100 of hydrogenating CO₂, according to certain embodiments of the present disclosure.

FIG. 13 is a schematic process flow chart depicting a method 200 of making a catalyst, according to certain embodiments of the present disclosure.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting.

In the drawings, like reference numerals designate identical or corresponding parts throughout the several views. As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used herein, the terms “room temperature” and “ambient temperature” refer to a temperature in a range of 25 degrees Celsius (° C.)±3° C. in the present disclosure.

As used herein, the terms “particle size” and “pore size” are thought of as the lengths or longest dimensions of a particle and of a pore opening, respectively.

As used herein, the term “de-ionized water” refers to the water that has (most of) the ions removed.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The present disclosure provides multi-metal catalysts that contain iron (Fe). The present disclosure also provides methods of hydrogenating carbon dioxide (CO₂) using the catalyst. Further, the present disclosure provides methods for making the catalyst.

Provided in the present disclosure are methods of hydrogenating carbon dioxide (CO₂). The methods of the present disclosure can be effective in producing high-value products, e.g., alcohols and light olefins, from CO₂ (e.g., under relatively mild conditions). In some embodiments, the methods can achieve relatively high yield and production rates. Additionally, the present disclosure includes methods of making a catalyst. In general, a catalyst containing iron (Fe), one or more alkali metals, and one or more metals selected from the group consisting of copper (Cu), zinc (Zn), and magnesium (Mg), can be prepared through a co-precipitation process. This can result in relatively enhanced stability and relatively controlled morphologies. Such a catalyst can be suitable, for example, for large-scale production and/or manufacturing applications.

According to an aspect of the present disclosure, a catalyst is provided. In some embodiments, the catalyst contains Fe, one or more alkali metals, and one or more metals selected from the group consisting of Cu, Zn, and Mg.

In some embodiments, the one or more alkali metals of the catalyst include potassium (K), and sodium (Na). In some embodiments, the one or more alkali metals of the catalyst include K. In some embodiments, the one or more alkali metals of the catalyst include Na.

In some embodiments, the catalyst is selected from the group consisting of a copper-iron (CuFe) catalyst, a zinc-iron (ZnFe) catalyst, a magnesium-iron (MgFe) catalyst, a copper-magnesium-iron (CuMgFe) catalyst, a copper-zinc-iron (CuZnFe) catalyst, a zinc-magnesium-iron (ZnMgFe) catalyst, a copper-zinc-magnesium-iron (CuZnMgFe) catalyst, a potassium-copper-iron (K—CuFe) catalyst, a potassium-zinc-iron (K—ZnFe) catalyst, a potassium-magnesium-iron (K—MgFe) catalyst, a potassium-copper-magnesium-iron (K—CuMgFe) catalyst, a potassium-copper-zinc-iron (K—CuZnFe) catalyst, a potassium-zinc-magnesium-iron (K—ZnMgFe) catalyst, a potassium-copper-zinc-magnesium-iron (K—CuZnMgFe) catalyst, a sodium-copper-iron (Na—CuFe) catalyst, a sodium-zinc-iron (Na—ZnFe) catalyst, a sodium-magnesium-iron (Na—MgFe) catalyst, a sodium-copper-magnesium-iron (Na—CuMgFe) catalyst, a sodium-copper-zinc-iron (Na—CuZnFe) catalyst, a sodium-zinc-magnesium-iron (Na—ZnMgFe) catalyst, and a sodium-copper-zinc-magnesium-iron (Na—CuZnMgFe) catalyst. In some embodiments, the catalyst includes a K—CuFe catalyst, a K—CuZnFe catalyst, a K—CuMgFe catalyst, a K—CuZnMgFe catalyst, and mixtures thereof. In some embodiments, the catalyst is a K—CuFe catalyst. In some embodiments, the catalyst is a K—CuZnFe catalyst. In some embodiments, the catalyst is a K—CuMgFe catalyst. In some embodiments, the catalyst is a K—CuZnMgFe catalyst.

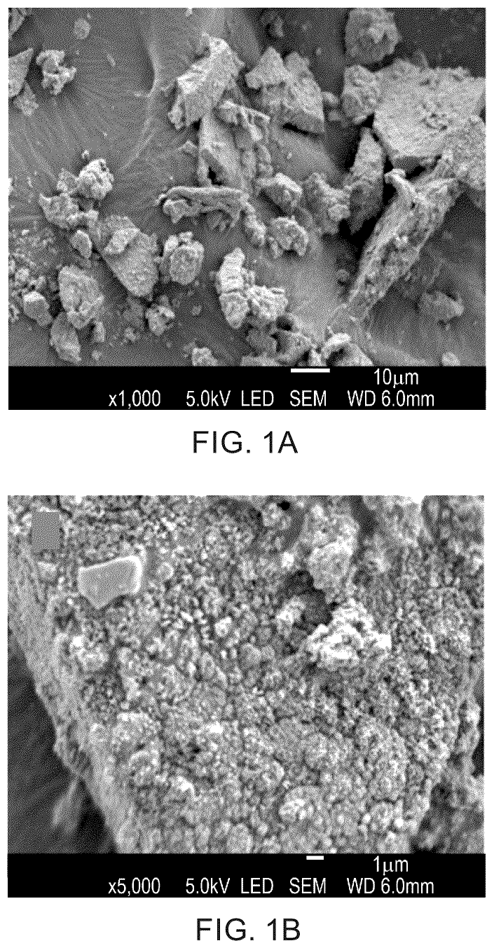

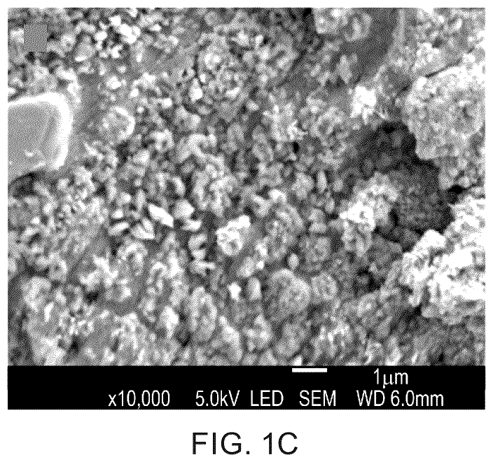

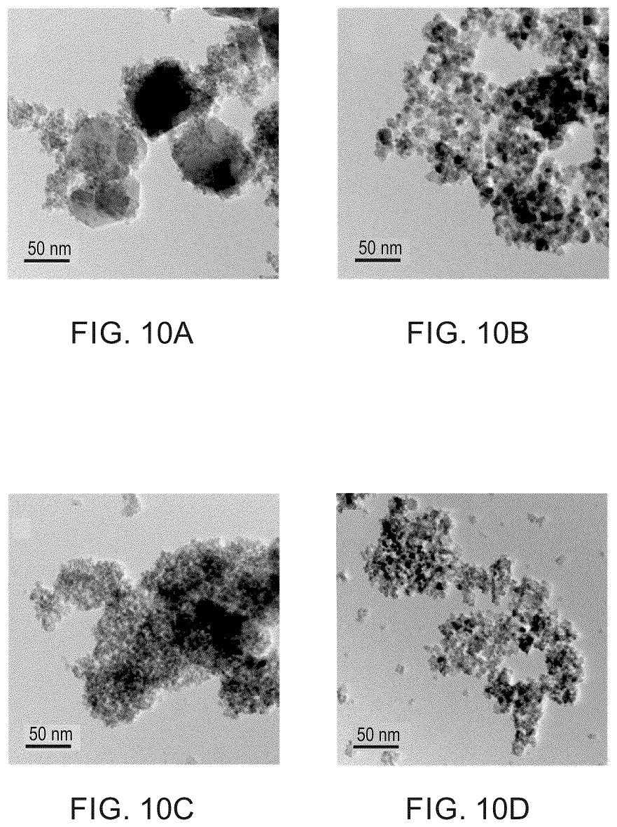

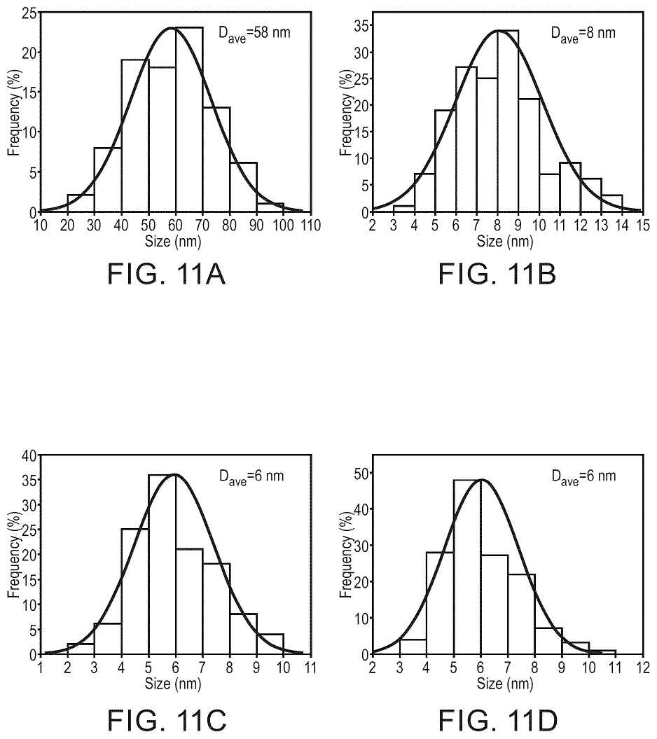

As described in more detail below, FIG. 10A is a TEM image of K—CuFe catalysts, FIGS. 1A-1C are SEMs of K—CuFe catalysts comprising irregularly shaped particles, and FIG. 11A illustrates a particle size distribution of the K—CuFe catalyst. In some embodiments, the irregularly shaped particles of a K—CuFe catalyst have sharp edges and rough surfaces. In some embodiments, the irregularly shaped particles of a K—CuFe catalyst have an average particle size of about 30 to about 100 nanometers (nm), such as about 35 to about 90 nm, about 40 to about 80 nm, about 45 to about 70 nm, about 50 to about 60 nm, or about 36 nm, about 42 nm, about 48 nm, about 54 nm, about 60 nm, about 66 nm, about 72 nm, about 78 nm, about 84 nm, about 90 nm, or about 96 nm. In some embodiments, the irregularly shaped particles of a K—CuFe catalyst have an average particle size of about 58 nm. In some embodiments, the irregularly shaped particles of a K—CuFe catalyst form aggregates via intermolecular force having a particle size ranging from about 1 to about 10 micrometers (μm), such as about 1.5 to about 8 μm, about 2 to about 6 μm, about 2.5 to about 4 μm, or about 4 μm.

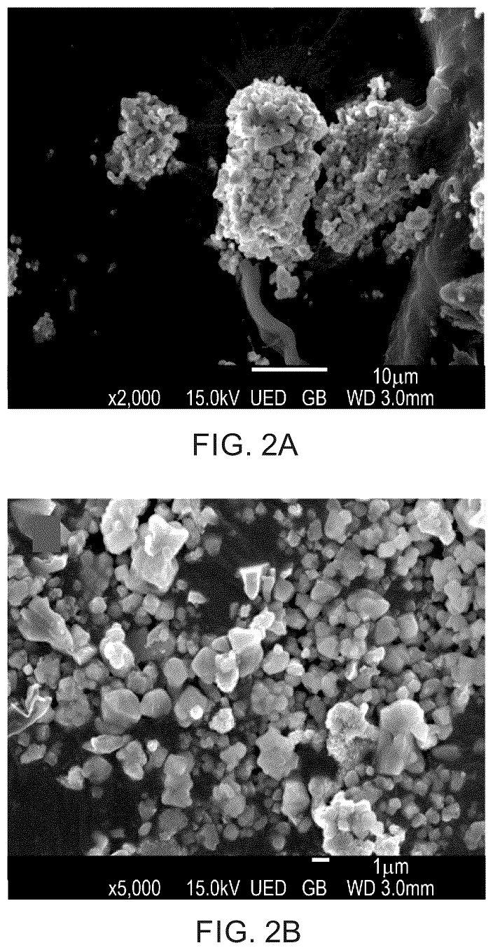

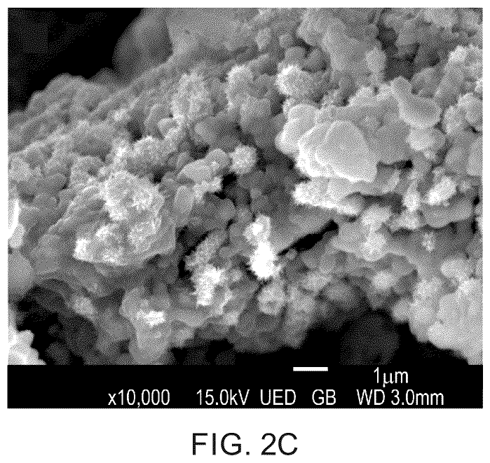

As described in detail below, FIG. 10B is a TEM image of K—CuZnFe catalysts, and FIG. 11B illustrates a particle size distribution of the K—CuZnFe catalysts. FIGS. 2A-2C show SEMs of K—CuZnFe catalysts comprising particles having an average particle size of about 2 to about 20 nm, such as about 4 to about 16 nm, about 6 to about 12 nm, or about 8 nm. In some embodiments, K—CuZnFe catalyst particles have an average particle size of about 8 nm. In some embodiments, K—CuZnFe catalyst particles form irregularly shaped clusters and aggregates via intermolecular force. The irregularly shaped clusters and aggregates can be loosely bounded having a particle size ranging from about 1 to about 7 μm, such as about 1.5 to about 6 μm, about 2 to about 5 μm, about 2.5 to about 4 μm, or about 3 μm. In some embodiments, the irregularly shaped clusters and aggregates of a K—CuZnFe catalyst have a rough, flaky surface, and whisker texture.

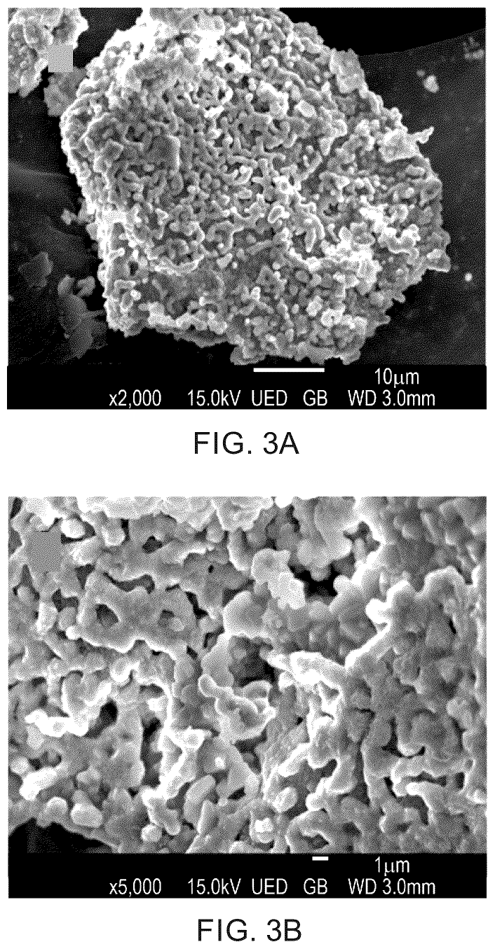

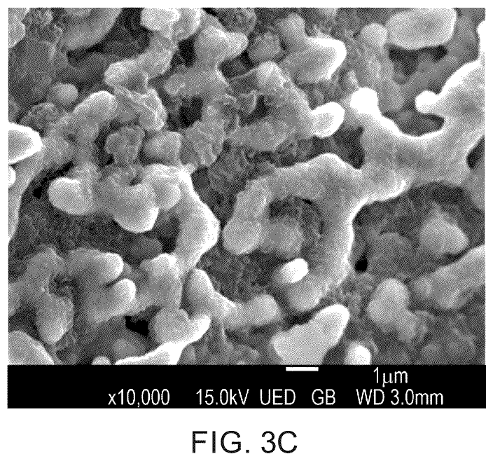

As described in detail below, FIG. 10C is a TEM image of K—CuMgFe catalysts and FIG. 11C illustrates a particle size distribution of the K—CuMgFe catalysts. FIGS. 3A-3C show SEMs of K—CuMgFe catalysts comprising particles of an average size of about 1 to about 15 nm, such as about 3 to about 13 nm, about 5 to about 11 nm, about 7 to about 9 nm, or about 7 nm. In some embodiments, K—CuMgFe catalyst particles form porous strand-like aggregates in the form of interconnected network via intermolecular force. Strand-like aggregates of a K—CuMgFe catalyst can have a length ranging from about 3 to about 20 μm, such as about 5 to about 18 μm, about 7 to about 16 μm, about 9 to about 14 μm, or about 9 to about 12 μm. Strand-like aggregates of a K—CuMgFe catalyst can have a width ranging from about 100 to about 900 nm, such as about 200 to about 800 nm, about 300 to about 700 nm, about 400 to about 600 nm, or about 500 nm.

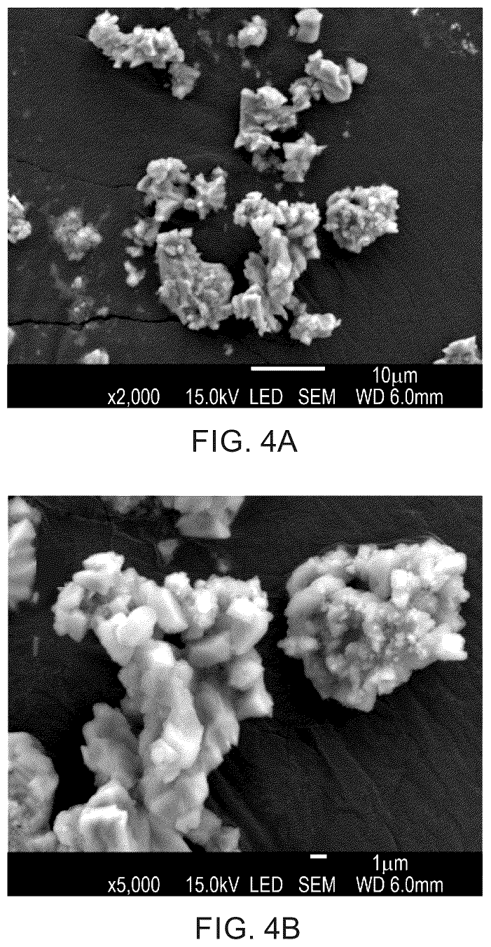

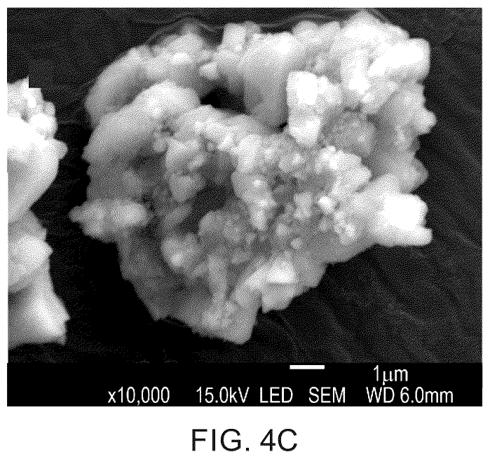

As described in detail below, FIG. 10D is a TEM image of K—CuZnMgFe catalysts, and FIG. 11D illustrates a particle size distribution of the K—CuZnMgFe catalysts. FIGS. 4A-4C show SEMS of K—CuZnMgFe catalysts comprising three-dimensional shape particles, which may be, for example, polyhedral particles. Some suitable polyhedron particle shapes may include tetrahedra, hexahedrons, hexahedrons, octahedrons, spheres, tetrahedrons, and combinations thereof. In some embodiments, a K—CuZnMgFe catalyst containing polyhedral particles has an average particle size of about 1 to about 20 nm, such as about 2 to about 18 nm, about 3 to about 16 nm, about 4 to about 14 nm, about 5 to about 12 nm, about 6 to about 10 nm, or about 6 to about 8 nm. In some embodiments, a K—CuZnMgFe catalyst polyhedral particles has an average particle size of about 6 nm. In some embodiments, K—CuZnMgFe catalyst polyhedral particles have an average particle size of about 7 nm. In some embodiments, K—CuZnMgFe catalyst polyhedral particles have an average particle size of about 8 nm.

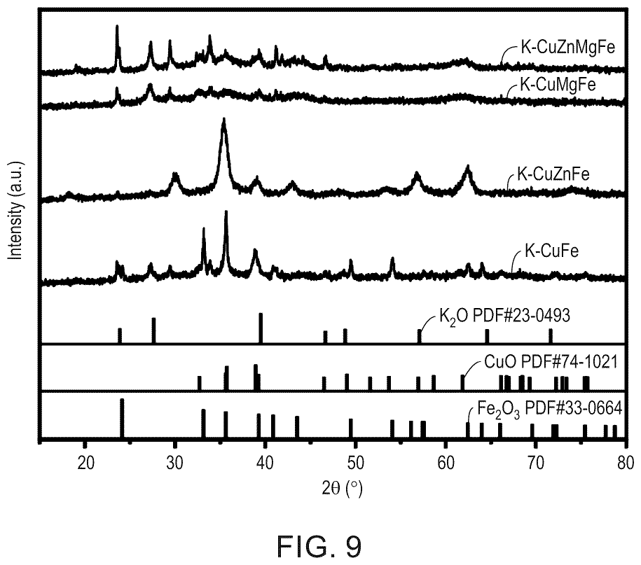

As described in more detail below, FIG. 9 discloses X-ray diffraction (XRD) data for various multi-metal catalysts. The data provide information regarding the crystalline structure of the catalysts. The catalysts include a K—CuFe catalyst, a K—CuZnFe catalyst, a K—CuMgFe catalyst, and a K—CuZnMgFe catalyst. In some embodiments, the XRD patterns are collected in a Rigaku Miniflex 600 X-ray diffractometer equipped with a Cu-K_{α} radiation source (λ=1.5406 Å) for a 20 range extending between 1° and 90°, such as 20 and 70° or 30 and 50° at an angular rate of 0.005 to 0.04° s⁻¹, such as 0.01 to 0.03° s⁻¹, or about 0.02° s⁻¹.

In some embodiments, a K—CuFe catalyst has peaks with a 20 value of about 22 to about 29°, such as about 22.5 to about 28.5°, about 23 to about 28°, about 23.5 to about 27.5°, about 24 to about 27°, about 24.5 to about 26.5°, about 25 to about 26°, or about 25.5 to about 26°. In some embodiments, a K—CuFe catalyst has peaks with a 20 value of about 29 to about 32°, such as about 29.5 to about 31.5°, about 30 to about 31°, about 30.5 to about 31°, or about 30.5°. In some embodiments, a K—CuFe catalyst has peaks with a 20 value of about 33 to about 37°, such as about 33.5 to about 36.5°, about 34 to about 36°, about 34.5 to about 35.5°, about 34.5 to about 35°, or about 34.5°. In some embodiments, a K—CuFe catalyst has peaks with a 20 value of about 37 to about 43°, such as about 37.5 to about 42.5°, about 38 to about 42°, about 38.5 to about 41.5°, about 39 to about 41°, about 39.5 to about 40.5°, or about 40°. In some embodiments, a K—CuFe catalyst has peaks with a 20 value of about 50 to about 65°, such as about 52 to about 63°, about 54 to about 61°, about 56 to about 59°, about 58 to about 59°, or about 58.5°. In some embodiments, a K—CuFe catalyst has peaks with a 20 value of about 24.5°, about 27.5° about 33°, about 35.5°, about 38.5°, about 50°, about 54.5°, and about 62°.

In some embodiments, a K—CuMgFe catalyst has peaks with a 20 value of about 22 to about 29°, such as about 22.5 to about 28.5°, about 23 to about 28°, about 23.5 to about 27.5°, about 24 to about 27°, about 24.5 to about 26.5°, about 25 to about 26°, or about 25.5 to about 26°. In some embodiments, a K—CuMgFe catalyst has peaks with a 20 value of about 29 to about 32°, such as about 29.5 to about 31.5°, about 30 to about 31°, about 30.5 to about 31°, or about 30.5°. In some embodiments, a K—CuMgFe catalyst has peaks with a 20 value of about 32 to about 42°, such as about 33 to about 41°, about 34 to about 40°, about 35 to about 39°, about 36 to about 38°, or about 37°. In some embodiments, a K—CuMgFe catalyst has peaks with a 20 value of about 55 to about 65°, such as about 57 to about 63°, about 59 to about 61°, or about 60°. In some embodiments, a K—CuMgFe catalyst has peaks with a 20 value of about 18°, about 27°, about 31°, about 33°, and about 60°.

In some embodiments, a K—CuZnFe catalyst has peaks with a 20 value of about 25 to about 33°, such as about 26 to about 32°, about 27 to about 31°, about 28 to about 30°, about 29 to about 30°, or about 30°. In some embodiments, a K—CuZnFe catalyst has peaks with a 20 value of about 33 to about 37°, such as about 33.5 to about 36.5°, about 34 to about 36°, about 34.5 to about 35.5°, about 35 to about 35.5°, or about 35.5°. In some embodiments, a K—CuZnFe catalyst has peaks with a 20 value of about 37 to about 41°, such as about 37.5 to about 40.5°, about 38 to about 40°, about 38.5 to about 39.5°, about 39 to about 39.5°, or about 39.5°. In some embodiments, a K—CuZnFe catalyst has peaks with a 20 value of about 41 to about 45°, such as about 41.5 to about 44.5°, about 42 to about 44°, about 42.5 to about 43.5°, about 42 to about 43°, or about 42.5°. In some embodiments, a K—CuZnFe catalyst has peaks with a 20 value of about 55 to about 60°, such as about 55.5 to about 59.5°, about 56 to about 59°, about 56.5 to about 58.5°, about 57 to about 58°, or about 57.5°. In some embodiments, a K—CuZnFe catalyst has peaks with a 20 value of about 60 to about 65°, such as about 60.5 to about 64.5°, about 61 to about 64°, about 61.5 to about 63.5°, about 62 to about 63°, or about 62.5°. In some embodiments, a K—CuZnFe catalyst has peaks with a 20 value of about 30°, about 35.5°, about 39.5°, about 42.5°, about 57.5°, and about 62.5°.

In some embodiments, a K—CuZnMgFe catalyst has peaks with a 20 value of about 22 to about 25°, such as about 22.5 to about 24.5°, about 23 to about 24°, about 23.5 to about 24°, or about 23.5°. In some embodiments, a K—CuZnMgFe catalyst has peaks with a 20 value of about 25 to about 29°, such as about 25.5 to about 28.5°, about 26 to about 28°, about 26.5 to about 27.5°, or about 27°. In some embodiments, a K—CuZnMgFe catalyst has peaks with a 20 value of about 29 to about 32°, such as about 29.5 to about 31.5°, about 30 to about 31°, about 30.5 to about 31°, or about 30.5°. In some embodiments, a K—CuZnMgFe catalyst has peaks with a 20 value of about 32 to about 42°, such as about 33 to about 41°, about 34 to about 40°, about 35 to about 39°, about 36 to about 38°, or about 37°. In some embodiments, a K—CuZnMgFe catalyst has peaks with a 20 value of about 55 to about 65°, such as about 57 to about 63°, about 59 to about 61°, or about 60°. In some embodiments, a K—CuZnMgFe catalyst has peaks with a 20 value of about 18°, about 27°, about 29.5°, about 31°, about 33.5°, about 35.5°, about 40°, and about 60°.

In some embodiments, a molar ratio of Fe to the one or more metals is from about 5:1 to about 1:5, such as from about 4:1 to about 1:4, from about 3:1 to about 1:3, from about 2:1 to about 1:2, or from about 2:1 to about 2:3. In some embodiments, the molar ratio of Fe to the one or more metals is from about 2:1 to about 2:3. In some embodiments, the molar ratio of Fe to the one or more metals is about 2:1. In some embodiments, the molar ratio of Fe to the one or more metals is about 1:1. In some embodiments, the molar ratio of Fe to the one or more metals is about 2:3.

In some embodiments, the one or more alkali metals are present in the catalyst in an amount of from about 0.1 to about 30 wt. % based on a total weight of the catalyst, such as from about 1 to 25 wt. %, from about 5 to about 20 wt. %, from about 10 to about 15 wt. %, or about 5 wt. %, about 7.5 wt. %, about 10 wt. %, about 12.5 wt. %, or about 15 wt. % based on the total weight of the catalyst. In some embodiments, the one or more alkali metals are present in the catalyst in an amount of about 8 wt. %. In some embodiments, the one or more alkali metals are present in the catalyst in an amount of about 9 wt. %. In some embodiments, the one or more alkali metals are present in the catalyst in an amount of about 10 wt. %. In some embodiments, the one or more alkali metals are present in the catalyst in an amount of about 11 wt. %. In some embodiments, the one or more alkali metals are present in the catalyst in an amount of about 12 wt. %. In some embodiments, the one or more alkali metals are present in the catalyst in an amount of about 13 wt. %.

In some embodiments, the one or more alkali metals are K. In some embodiments, the K is present in the catalyst in an amount of from about 0.1 to about 30 wt. % based on a total weight of the catalyst, such as from about 1 to 25 wt. %, from about 5 to about 20 wt. %, from about 10 to about 15 wt. %, or about 5 wt. %, about 7.5 wt. %, about 10 wt. %, about 12.5 wt. %, or about 15 wt. % based on the total weight of the catalyst. In some embodiments, the K is present in the catalyst in an amount of about 8 wt. %. In some embodiments, the K is present in the catalyst in an amount of about 9 wt. %. In some embodiments, the K is present in the catalyst in an amount of about 10 wt. %. In some embodiments, the K is present in the catalyst in an amount of about 11 wt. %. In some embodiments, the K is present in the catalyst in an amount of about 12 wt. %. In some embodiments, the K is present in the catalyst in an amount of about 13 wt. %.

In some embodiments, the catalyst contains Fe, Cu, K, and one or more metals selected from the group consisting of Zn and Mg. In some embodiments, a molar ratio of Cu to a total of the Fe and one or more metals selected from the group consisting of Zn and Mg is from about 2:1 to about 1:12, from about 1:1 to about 1:8, from about 1:2 to about 1:4, or about 1:1, about 1:2, about 1:3, about 1:4, about 1:5, or about 1:6. In some embodiments, the molar ratio of Cu to a total of the Fe and one or more metals selected from the group consisting of Zn and Mg is from about 1:2 to about 1:4. In some embodiments, the molar ratio of Cu to a total of the Fe and one or more metals selected from the group consisting of Zn and Mg is about 1:2. In some embodiments, the molar ratio of Cu to a total of the Fe and one or more metals selected from the group consisting of Zn and Mg is about 1:3. In some embodiments, the molar ratio of Cu to a total of the Fe and one or more metals selected from the group consisting of Zn and Mg is about 1:4.

In some embodiments, the catalyst contains Fe, Zn, K, and one or more metals selected from the group consisting of Cu and Mg. In some embodiments, a molar ratio of Zn to a total of the Fe and one or more metals selected from the group consisting of Cu and Mg present in the catalyst is from about 1:2 to about 1:18, such as from about 1:3 to about 1:15, from about 1:4 to about 1:12, from about 1:5 to about 1:12, from about 1:6 to about 1:9, from about 1:7 to about 1:8, or about 1:4, about 1:5, about 1:6, about 1:7, about 1:8, or about 1:9. In some embodiments, the molar ratio of Zn to a total of the Fe and one or more metals selected from the group consisting of Cu and Mg is from about 1:6 to about 1:9. In some embodiments, the molar ratio of Zn to a total of the Fe and one or more metals selected from the group consisting of Cu and Mg is about 1:6. In some embodiments, the molar ratio of Zn to a total of the Fe and one or more metals selected from the group consisting of Cu and Mg is about 1:7. In some embodiments, the molar ratio of Zn to a total of the Fe and one or more metals selected from the group consisting of Cu and Mg is about 1:8. In some embodiments, the molar ratio of Zn to a total of the Fe and one or more metals selected from the group consisting of Cu and Mg is about 1:9.

In some embodiments, the catalyst contains Fe, Mg, K, and one or more metals selected from the group consisting of Cu and Zn. In some embodiments, a molar ratio of Mg to a total of the Fe and one or more metals selected from the group consisting of Cu and Zn present is from about 4:1 to about 1:20, such as from about 2:1 to about 1:15, from about 1:1 to about 1:10, from about 1:2 to about 3:10, or about 1:1, about 1:2, about 1:3, or about 1:4. In some embodiments, the molar ratio of Mg to a total of the Fe and one or more metals selected from the group consisting of Cu and Zn is from about 1:2 to about 3:10. In some embodiments, the molar ratio of Mg to a total of the Fe and one or more metals selected from the group consisting of Cu and Zn is about 1:2. In some embodiments, the molar ratio of Mg to a total of the Fe and one or more metals selected from the group consisting of Cu and Zn is about 1:3. In some embodiments, the molar ratio of Mg to a total of the Fe and one or more metals selected from the group consisting of Cu and Zn is about 3:10.

In some embodiments, the catalyst contains about 15 to about 45 wt. % Fe, about 3 to about 20 wt. % K, about 10 to about 30 wt. % Cu, and oxygen (O) as a balance, each wt. % based on a total weight of the catalyst. In some embodiments, such a catalyst contains from about 15 to about 45 wt. % Fe, such as from about 18 to about 42 wt. % Fe, from about 21 to about 39 wt. % Fe, from about 24 to about 36 wt. % Fe, from about 27 to about 33 wt. % Fe, or about 20 wt. % Fe, about 25 wt. % Fe, about 30 wt. % Fe, about 35 wt. % Fe, or about 40 wt. % Fe based on the total weight of the catalyst. In some embodiments, such a catalyst contains from about 3 to about 20 wt. % K, such as from about 5 to about 18 wt. % K, from about 7 to about 16 wt. % K, from about 9 to 14 wt. % K, from about 11 to about 12 wt. % K, or about 6 wt. % K, about 9 wt. % K, about 12 wt. % K, about 15 wt. % K, or about 18 wt. % K based on the total weight of the catalyst. In some embodiments, such a catalyst contains from about 10 to about 30 wt. % Cu, such as from about 13 to about 27 wt. % Cu, from about 16 to about 24 wt. % Cu, from about 19 to about 21 wt. % Cu, or about 12 wt. % Cu, about 14 wt. % Cu, about 16 wt. % Cu, about 18 wt. % Cu, about 20 wt. % Cu, about 22 wt. % Cu, or about 24 wt. % Cu based on the total weight of the catalyst. In some embodiments, such a catalyst contains from about 25 to about 35 wt. % Fe, from about 5 to about 15 wt. % K, from about 15 to about 25 wt. % Cu, and O as a balance. In some embodiments, such a catalyst contains about 30 wt. % Fe, about 10 wt. % K, about 20 wt. % Cu, and O as a balance. In some embodiments, such a catalyst contains about 32.67 wt. % Fe, about 9.98 wt. % K, about 20.01 wt. % Cu, and O as a balance.

In some embodiments, the catalyst contains from about 15 to about 45 wt. % Fe, from about 6 to about 25 wt. % K, from about 10 to about 30 wt. % Cu, from about 3 to about 20 wt. % Zn, and O as a balance, each wt. % based on a total weight of the catalyst. In some embodiments, such a catalyst contains from about 15 to about 45 wt. % Fe, such as from about 18 to about 42 wt. % Fe, from about 21 to about 39 wt. % Fe, from about 24 to about 36 wt. % Fe, from about 27 to about 33 wt. % Fe, or about 20 wt. % Fe, about 25 wt. % Fe, about 30 wt. % Fe, about 35 wt. % Fe, or about 40 wt. % Fe based on the total weight of the catalyst. In some embodiments, such a catalyst contains from about 6 to about 25 wt. % K, such as from about 8 to about 23 wt. % K, from about 10 to about 21 wt. % K, from about 12 to 19 wt. % K, from about 14 to about 17 wt. % K, or about 9 wt. % K, about 12 wt. % K, about 15 wt. % K, about 18 wt. % K, about 21 wt. % K, or about 24 wt. % K based on the total weight of the catalyst. In some embodiments, such a catalyst contains from about 10 to about 30 wt. % Cu, such as from about 13 to about 27 wt. % Cu, from about 16 to about 24 wt. % Cu, from about 19 to about 21 wt. % Cu, or about 12 wt. %, about 14 wt. % Cu, about 16 wt. % Cu, about 18 wt. % Cu, about 20 wt. % Cu, about 22 wt. % Cu, or about 24 wt. % Cu based on the total weight of the catalyst. In some embodiments, such a catalyst contains from about 3 to about 20 wt. % Zn, such as from about 5 to about 18 wt. % Zn, from about 7 to about 16 wt. % Zn, from about 9 to 14 wt. % Zn, from about 11 to about 12 wt. % Zn, or about 6 wt. % Zn, about 9 wt. % Zn, about 12 wt. % Zn, about 15 wt. % Zn, or about 18 wt. % Zn based on the total weight of the catalyst. In some embodiments, such a catalyst contains from about 25 to about 35 wt. % Fe, from about 8 to about 16 wt. % K, from about 15 to about 25 wt. % Cu, from about 7 to about 13 wt. % Zn, and O as a balance. In some embodiments, such a catalyst contains about 30 wt. % Fe, about 10 wt. % K, about 20 wt. % Cu, about 10 wt. % Zn, and O as a balance. In some embodiments, such a catalyst contains about 32.45 wt. % Fe, about 11.15 wt. % K, about 19.91 wt. % Cu, about 9.85 wt. % Zn, and O as a balance.

In some embodiments, the catalyst contains from about 10 to about 35 wt. % Fe, from about 6 to about 25 wt. % K, from about 10 to about 30 wt. % Cu, from about 1 to about 10 wt. % Mg, and O as a balance, each wt. % based on a total weight of the catalyst. In some embodiments, such a catalyst contains from about 10 to about 35 wt. % Fe, such as from about 13 to about 32 wt. % Fe, from about 16 to about 29 wt. % Fe, from about 19 to about 26 wt. % Fe, from about 22 to about 23 wt. % Fe, or about 15 wt. % Fe, about 20 wt. % Fe, about 25 wt. % Fe, about 30 wt. % Fe, or about 35 wt. % Fe based on the total weight of the catalyst. In some embodiments, the catalyst contains from about 6 to about 25 wt. % K, such as from about 8 to about 23 wt. % K, from about 10 to about 21 wt. % K, from about 12 to 19 wt. % K, from about 14 to about 17 wt. % K, or about 9 wt. % K, about 12 wt. % K, about 15 wt. % K, about 18 wt. % K, about 21 wt. % K, or about 24 wt. % K based on the total weight of the catalyst. In some embodiments, such a catalyst contains from about 10 to about 30 wt. % Cu, such as from about 13 to about 27 wt. % Cu, about 16 to about 24 wt. % Cu, from about 19 to about 21 wt. % Cu, or about 12 wt. % Cu, about 14 wt. % Cu, about 16 wt. % Cu, about 18 wt. % Cu, about 20 wt. % Cu, about 22 wt. % Cu, or about 24 wt. % Cu based on the total weight of the catalyst. In some embodiments, such a catalyst contains from about 1 to about 10 wt. % Mg, such as from about 2 to about 9 wt. % Mg, from about 3 to about 8 wt. % Mg, from about 4 to about 7 wt. % Mg, from about 5 to about 6 wt. % Mg, or about 1.5 wt. % Mg, about 2.5 wt. % Mg, about 3.5 wt. % Mg, about 4.5 wt. % Mg, about 5.5 wt. % Mg, about 6.5 wt. % Mg, about 7.5 wt. % Mg, about 8.5 wt. % Mg, or about 9.5 wt. % Mg based on the total weight of the catalyst. In some embodiments, such a catalyst contains from about 20 to about 30 wt. % Fe, from about 7 to about 15 wt. % K, from about 10 to about 20 wt. % Cu, from about 2 to about 8 wt. % Mg, and O as a balance. In some embodiments, such a catalyst contains about 25 wt. % Fe, about 12 wt. % K, about 15 wt. % Cu, about 5 wt. % Mg, and O as a balance. In some embodiments, such a catalyst contains about 24.05 wt. % Fe, about 10.40 wt. % K, about 14.94 wt. % Cu, about 5.71 wt. % Mg, and O as a balance.

In some embodiments, the catalyst contains from about 5 to about 30 wt. % Fe, from about 6 to about 25 wt. % K, from about 2 to about 20 wt. % Cu, from about 1 to about 10 wt. % Zn, from about 1 to about 10 wt. % Mg, and oxygen (O) as a balance, each wt. % based on a total weight of the catalyst. In some embodiments, such a catalyst contains from about 5 to about 30 wt. % Fe, such as from about 8 to about 27 wt. % Fe, from about 11 to about 24 wt. % Fe, from about 14 to about 21 wt. % Fe, from about 17 to about 18 wt. % Fe, or about 7 wt. % Fe, about 12 wt. % Fe, about 17 wt. % Fe, about 22 wt. % Fe, or about 27 wt. % Fe based on the total weight of the catalyst. In some embodiments, such a catalyst contains from about 6 to about 25 wt. % K, such as from about 8 to about 23 wt. % K, from about 10 to about 21 wt. % K, from about 12 to about 19 wt. % K, from about 14 to about 17 wt. % K, or about 9 wt. % K, about 12 wt. % K, about 15 wt. % K, about 18 wt. % K, about 21 wt. % K, or about 24 wt. % K based on the total weight of the catalyst. In some embodiments, such a catalyst contains from about 2 to about 20 wt. % Cu, such as from about 4 to about 18 wt. % Cu, from about 6 to about 16 wt. % Cu, from about 8 to about 14 wt. % Cu, from about 10 to about 12 wt. % Cu, or about 5 wt. % Cu, about 8 wt. % Cu, about 11 wt. % Cu, about 14 wt. % Cu, about 17 wt. % Cu, or about 20 wt. % Cu based on the total weight of the catalyst. In some embodiments, such a catalyst contains from about 1 to about 10 wt. % Zn, such as from about 2 to about 9 wt. % Zn, from about 3 to about 8 wt. % Zn, from about 4 to about 7 wt. % Zn, from about 5 to about 6 wt. % Zn, or about 1.5 wt. % Zn, about 2.5 wt. % Zn, about 3.5 wt. % Zn, about 4.5 wt. % Zn, about 5.5 wt. % Zn, about 6.5 wt. % Zn, about 7.5 wt. % Zn, about 8.5 wt. % Zn, or about 9.5 wt. % Zn based on the total weight of the catalyst. In some embodiments, such a catalyst contains from about 1 to about 10 wt. % Mg, such as from about 2 to about 9 wt. % Mg, from about 3 to about 8 wt. % Mg, from about 4 to about 7 wt. % Mg, from about 5 to about 6 wt. % Mg, or about 1.5 wt. % Mg, about 2.5 wt. % Mg, about 3.5 wt. % Mg, about 4.5 wt. % Mg, about 5.5 wt. % Mg, about 6.5 wt. % Mg, about 7.5 wt. % Mg, about 8.5 wt. % Mg, or about 9.5 wt. % Mg of the total weight of the catalyst. In some embodiments, the catalyst contains O as a balance.

In some embodiments, the catalyst contains from about 11 to about 21 wt. % Fe, from about 8 to about 18 wt. % K, from about 5 to about 15 wt. % Cu, from about 1 to about 9 wt. % Zn, from about 1 to about 9 wt. % Mg, and O as a balance. In some embodiments, such a catalyst contains from about 13 to about 19 wt. % Fe, from about 10 to about 16 wt. % K, from about 7 to about 13 wt. % Cu, from about 3 to about 7 wt. % Zn, from about 3 to about 7 wt. % Mg, and O as a balance. In some embodiments, such a catalyst contains from about 15 to about 17 wt. % Fe, from about 12 to about 14 wt. % K, from about 9 to about 11 wt. % Cu, from about 4 to about 6 wt. % Zn, from about 4 to about 6 wt. % Mg, and O as a balance. In some embodiments, such a catalyst contains about 16 wt. % Fe, about 13 wt. % K, about 10 wt. % Cu, about 5 wt. % Zn, about 5 wt. % Mg, and O as a balance. In some embodiments, such a catalyst contains about 15.76 wt. % Fe, about 12.36 wt. % K, about 9.56 wt. % Cu, about 4.96 wt. % Zn, about 4.76 wt. % Mg, and O as a balance.

According to an aspect of the present disclosure, a method of hydrogenating CO₂ includes introducing a hydrogen (H₂)-containing feed gas stream into a reactor containing the catalyst.

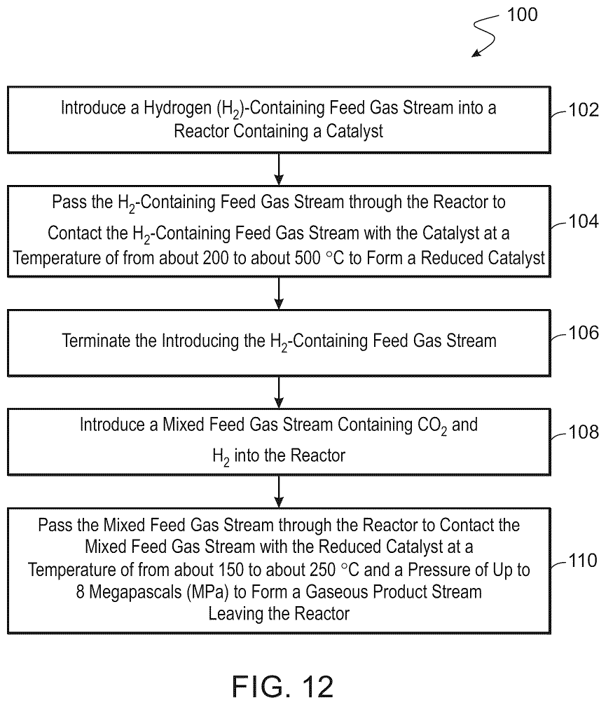

As described in more detail below, FIG. 12 shows a schematic flow chart of a method 100 of hydrogenating CO₂. The order in which the method 100 depicted in FIG. 12 is not intended to be construed as a limitation, and any number of the described method steps may be combined in any appropriate order to implement the method 100. Additionally, individual steps may be removed or skipped from the method 100, as appropriate, without departing from the spirit and scope of the present disclosure. Further, additional steps can be added to the method 100 as appropriate.

According to the method 100, a step 102 includes introducing a hydrogen (H₂)-containing feed gas stream into a reactor containing a catalyst. A step 104 includes passing the H₂-containing feed gas stream through the reactor to contact the H₂-containing feed gas stream with the catalyst at a temperature of from about 200 to about 500° C. to form a reduced catalyst. A step 106 includes terminating the introducing the H₂-containing feed gas stream. A step 108 includes introducing a mixed feed gas stream containing CO₂ and H₂ into the reactor. A step 110 includes passing the mixed feed gas stream through the reactor to contact the mixed feed gas stream with the reduced catalyst at a temperature of from about 150 to about 250° C. and a pressure of up to 8 megapascals (MPa) to form a gaseous product stream leaving the reactor.

In some embodiments, the H₂-containing feed gas stream further contains an inert gas selected from the group consisting of nitrogen, argon, and helium. In some embodiments, the H₂-containing feed gas stream further contains nitrogen. In some embodiments, the H₂ is present in the H₂-containing feed gas stream in an amount of about 70 to about 99.99 vol. % based on a total volume of the H₂-containing feed gas stream, such as about 75 to about 99.99 vol. %, about 80 to about 99.99 vol. %, about 85 to about 99.99 vol. %, about 90 to about 99.99 vol. %, about 95 to about 99.99 vol. %, or about 99 vol. % based on the total volume of the H₂-containing feed gas stream.

In some embodiments, the reactor is at least one selected from the group consisting of a fixed-bed reactor, a trickle-bed reactor, a moving bed reactor, a rotating bed reactor, a fluidized bed reactor, and a slurry reactor. In some embodiments, the reactor is a fixed-bed reactor in the form of a cylindrical reactor. In some embodiments, the cylindrical reactor includes a top portion, a cylindrical body portion, a bottom portion, a housing having an open top and open bottom supportably maintained with the cylindrical body portion. In some embodiments, the catalyst is supportably retained within the housing permitting fluid flow therethrough. In some embodiments, at least one propeller agitator disposed in the bottom portion of the cylindrical reactor. In some embodiments, the bottom portion is cone shaped or pyramidal. In some embodiments, a plurality of recirculation tubes fluidly connects the bottom portion of the cylindrical reactor with the cylindrical body portion of the cylindrical reactor.

In some embodiments, the method of hydrogenating CO₂ further includes passing the H₂-containing feed gas stream through the reactor to contact the H₂-containing feed gas stream with the catalyst at a temperature of about 200 to about 500° C. to form a reduced catalyst. In some embodiments, the H₂-containing feed gas stream is passed through the reactor at a flow rate of about 1 to about 50 milliliters per minute (mL/min), such as about 5 to about 45 mL/min, about 10 to about 40 mL/min, about 15 to about 35 mL/min, about 15 to about 30 mL/min, or about 20 mL/min. In some embodiments, the H₂-containing feed gas stream is passed through the reactor at a temperature of about 100 to about 600° C., about 150 to about 550° C., about 200 to about 500° C., about 250 to about 450° C., about 300 to about 400° C., or about 350° C. In some embodiments, the H₂-containing feed gas stream is passed through the reactor for about 0.1 to about 6 hours, such as about 0.5 to about 5 hours, about 1 to about 4 hours, about 1.5 to about 3 hours, or about 2 hours. In some embodiments, the H₂-containing feed gas stream is passed through the reactor at a flow rate of about 10 to about 30 mL/min at a temperature of about 200 to about 500° C. for about 2 hours. In some embodiments, the H₂-containing feed gas stream is passed through the reactor at a flow rate of about 20 mL/min at a temperature of about 350° C. for about 2 hours.

In some embodiments, the method of hydrogenating CO₂ further includes terminating the introducing the H₂-containing feed gas stream.

In some embodiments, the method of hydrogenating CO₂ further includes introducing a mixed feed gas stream containing CO₂ and H₂ into the reactor, and passing the mixed feed gas stream through the reactor to contact the mixed feed gas stream with the reduced catalyst at a temperature of about 150 to about 250° C. and a pressure of up to 8 megapascals (MPa) to form a gaseous product stream leaving the reactor. In some embodiments, the gaseous product stream contains a chemical reduction product of the CO₂.

In some embodiments, H₂ is present in the mixed feed gas stream at a concentration of about 35 to about 95 volume percentage (vol. %) based on a total volume of the mixed feed gas stream, such as about 40 to about 90 vol. %, about 45 to about 85 vol. %, about 50 to about 80 vol. %, about 55 to about 75 vol. %, about 60 to about 70 vol. %, or about 65 vol. %. In some embodiments, H₂ is present in the mixed feed gas stream at a concentration of about 72 vol. % based on the total volume of the mixed feed gas stream.

In some embodiments, CO₂ is present in the mixed feed gas stream at a concentration of about 1 to about 50 vol. % based on the total volume of the mixed feed gas stream, such as about 5 to about 45 vol. %, about 10 to about 40 vol. %, about 15 to about 35 vol. %, about 20 to about 30 vol. %, or about 25 vol. %. In some embodiments, CO₂ is present in the mixed feed gas stream at a concentration of about 24 vol. % based on the total volume of the mixed feed gas stream.

In some embodiments, a volume ratio of the H₂ to CO₂ in the mixed feed gas stream is about 10:1 to 1:5, such as about 9:1 to about 1:4, about 8:1 to about 1:3, about 7:1 to about 1:3, about 6:1 to about 1:2, about 5:1 to about 1:1, about 4:1 to about 2:1, or about 3:1. In some embodiments, a volume ratio of the H₂ to CO₂ in the mixed feed gas stream is about 3:1.

In some embodiments, the mixed feed gas stream further contains an inert gas selected from the group consisting of nitrogen, argon, and helium. In some embodiments, the mixed feed gas stream further contains nitrogen. In some embodiments, the mixed feed gas stream further contains argon. In some embodiments, the mixed feed gas stream further contains helium. In some embodiments, the inert gas is present in the mixed feed gas stream at a concentration of about 0.05 to about 10 vol. % based on the total volume of the mixed feed gas stream, such as about 0.1 to about 8.5 vol. %, about 1 to about 7.5 vol. %, about 2 to about 6.5 vol. %, about 3 to about 5.5 vol. %, or about 4 vol. % based on the total volume of the mixed feed gas stream. In some embodiments, the mixed feed gas stream further contains nitrogen in an amount of about 4 vol. % based on the total volume of the mixed feed gas stream.

In some embodiments, the mixed feed gas stream is passed through the reactor at a flow rate of about 1 to about 50 milliliters per minute (mL/min), such as about 5 to about 45 mL/min, about 10 to about 40 mL/min, about 15 to about 35 mL/min, about 15 to about 30 mL/min, or about 20 mL/min. In some embodiments, the mixed feed gas stream is passed through the reactor at a temperature of about 50 to about 350° C., about 75 to about 325° C., about 100 to about 300° C., about 125 to about 275° C., about 150 to about 250° C., about 175 to about 225° C., or about 200° C. In some embodiments, the mixed feed gas stream is passed through the reactor for about 1 to about 24 hours, such as about 2 to about 20 hours, about 3 to about 16 hours, about 4 to about 12 hours, about 6 to about 8 hours, or about 6 hours. In some embodiments, the mixed feed gas stream is passed through the reactor under a pressure of about 1 to about 10 MPa, such as about 2 to about 8 MPa, about 3 to about 6 MPa, or about 4 MPa. In some embodiments, the mixed feed gas stream is passed through the reactor at a flow rate of about 10 to about 30 mL/min at a temperature of about 150 to about 300° C. for about 2 to about 8 hours. In some embodiments, the mixed feed gas stream is passed through the reactor at a flow rate of about 10 to about 30 mL/min at a temperature of about 200° C. for about 6 hours.

In some embodiments, the method has a CO₂ conversation rate of about 5 to about 60% based on an initial concentration of CO₂ present in the mixed feed gas stream, such as about 10 to about 60%, about 15 to about 55%, about 20 to about 55%, about 25 to about 50%, about 30 to about 50%, about 35 to about 45%, or about 40 to about 45% based on the initial concentration of CO₂ present in the mixed feed gas stream. In some embodiments, the method has a CO₂ conversation rate of about 40% based on an initial concentration of CO₂ present in the mixed feed gas stream. In some embodiments, the method has a CO₂ conversation rate of about 45% based on an initial concentration of CO₂ present in the mixed feed gas stream. In some embodiments, the method has a CO₂ conversation rate of about 48% based on an initial concentration of CO₂ present in the mixed feed gas stream.

In some embodiments, the gaseous product stream includes about 1 to about 30% of carbon monoxide (CO), about 5 to about 60% of one or more paraffins, about 0.5 to about 25% of one or more alcohols, and about 25 to about 85% of one or more olefins, each % based on the CO₂ conversion rate. In some embodiments, the gaseous product stream includes about 5 to about 25% of CO, about 10 to about 50% of one or more paraffins, about 0.5 to about 20% of one or more alcohols, and about 30 to about 80% of one or more olefins, each % based on the CO₂ conversion rate. In some embodiments, the gaseous product stream includes about 10 to about 20% of CO, about 20 to about 40% of one or more paraffins, about 5 to about 15% of one or more alcohols, and about 40 to about 70% of one or more olefins, each % based on the CO₂ conversion rate. In some embodiments, the gaseous product stream includes about 10 to about 15% of CO, about 30 to about 35% of one or more paraffins, about 10 to about 15% of one or more alcohols, and about 50 to about 60% of one or more olefins, each % based on the CO₂ conversion rate.

In some embodiments, the gaseous product stream includes about 10% of one or more alcohols, and about 30% of one or more olefins. In some embodiments, the gaseous product stream includes about 11% of one or more alcohols, and about 35% of one or more olefins. In some embodiments, the gaseous product stream includes about 12% of one or more alcohols, and about 40% of one or more olefins. In some embodiments, the gaseous product stream includes about 13% of one or more alcohols, and about 42% of one or more olefins.

In some embodiments, the one or more paraffins includes C1-C4 light paraffins. In some embodiments, the one or more alcohols includes methanol and ethanol. In some embodiments, the one or more olefins includes C2-C4 light olefins.

In some embodiments, the method for hydrogenating CO₂ further includes regenerating the spend catalyst by washing the spend catalyst with two or more solvents and drying. In some embodiments, the two or more solvents are selected from the group consisting of aromatics, alkanes, ketones, glycols, chlorinated solvents, esters, ethers, amines, nitriles, aldehydes, phenols, amides, carboxylic acids, alcohols, furans, polar protic solvents, polar aprotic solvents, water, and mixtures thereof. In some embodiments, the two or more solvents are polar protic solvents, including but not limited to, water, acetone, N-methyl 2-pyrrolidone (NMP), acetonitrile, dimethylformamide (DMF), dimethyl sulfoxide (DMSO), isopropanol, methanol, and mixtures thereof. In some embodiments, the two or more solvents are water and NMP. In some embodiments, the drying the spend catalyst is carried out at a temperature of about 50 to about 100° C., such as about 55 to about 95° C., about 60 to about 90° C., about 65 to about 85° C., about 70 to about 80° C., or about 75° C. In further embodiments, the spend catalyst is dried at a temperature of about 75° C.

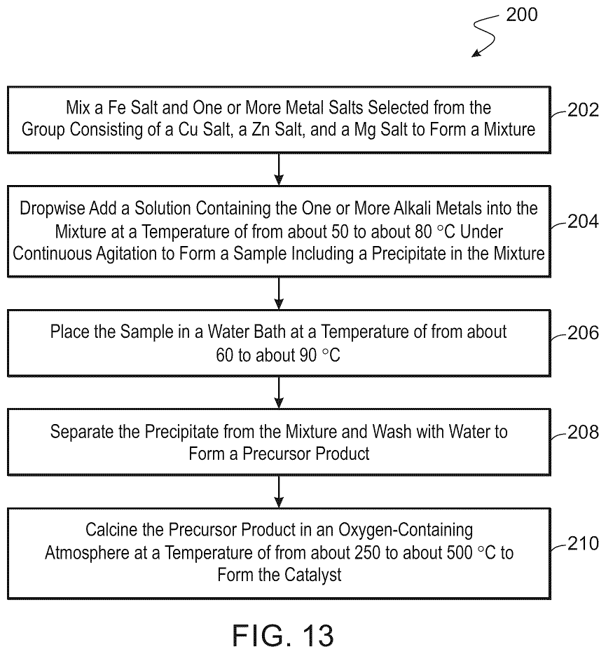

Also provided in the present disclosure is a method for preparing a catalyst. As described in more detail below, FIG. 13 shows a schematic flow chart of a method 200 of making a catalyst. The order in which the method 200 is described is not intended to be construed as a limitation, and any number of the described method steps may be combined in any appropriate order to implement the method 200. Additionally, individual steps may be removed or skipped from the method 200, as appropriate, without departing from the spirit and scope of the present disclosure. Further, additional steps may be added to the method 200 as appropriate.

The method 200 includes a step 202 that includes mixing a Fe salt and one or more metal salts selected from the group consisting of a Cu salt, a Zn salt, and a Mg salt to form a mixture. A step 204 includes dropwise adding a solution containing the one or more alkali metals into the mixture at a temperature of from about 50 to about 80° C. under continuous agitation to form a sample including a precipitate in the mixture. A step 206 includes placing the sample in a water bath at a temperature of from about 60 to about 90° C. A step 208 includes separating the precipitate from the mixture and wash with water to form a precursor product. A step 210 includes calcining the precursor product in an oxygen-containing atmosphere at a temperature of from about 250 to about 500° C. to form the catalyst.

The method of making the catalyst includes mixing a Fe salt and one or more metal salts selected from the group consisting of a Cu salt, a Zn salt, and a Mg salt to form a mixture. In some embodiments, the Fe salt includes iron sulfate, iron acetate, iron chloride, iron nitrate, iron carbonate, iron phosphate, iron oxalate, and/or a hydrate thereof. In some embodiments, the Cu salt includes copper sulfate, copper acetate, copper chloride, copper nitrate, copper carbonate, copper phosphate, copper oxalate, and/or a hydrate thereof. In some embodiments, the Zn salt includes zinc sulfate, zinc acetate, zinc chloride, zinc nitrate, zinc carbonate, zinc phosphate, zinc oxalate, and/or a hydrate thereof. In some embodiments, the Mg salt includes magnesium sulfate, magnesium acetate, magnesium chloride, magnesium nitrate, magnesium carbonate, magnesium phosphate, magnesium oxalate, and/or a hydrate thereof. In some embodiments, the Fe salt is iron nitrate. In some embodiments, the Cu salt is copper nitrate. In some embodiments, the Zn salt is zinc nitrate. In some embodiments, the Mg salt is magnesium nitrate.

In some embodiments, a total cation concentration of the Fe salt and one or more metal salts present in the mixture is about 0.03 to about 0.5 mol/L, such as about 0.05 to about 0.4 mol/L, about 0.1 to about 0.3 mol/L, about 0.2 to about 0.3 mol/L, or about 0.2 mol/L.

In some embodiments, the method for preparing the catalyst further includes dropwise adding a solution containing the one or more alkali metals into the mixture at a temperature of about 50 to about 80° C. under continuous agitation to form a sample containing a precipitate in the mixture. In some embodiments, the one or more alkali metal salts includes sodium carbonate, sodium acetate, sodium sulfide, sodium bicarbonate, sodium hydroxide, potassium carbonate, potassium acetate, potassium sulfide, potassium bicarbonate, potassium hydroxide, or combinations thereof. In some embodiments, the one or more alkali metal salts includes sodium carbonate, sodium hydroxide, potassium carbonate, and potassium hydroxide. In some embodiments, the one or more alkali metal salts includes potassium carbonate and potassium hydroxide. In some embodiments, the solution is added into the mixture at a temperature of about 50 to about 80° C., such as about 55 to about 75° C., about 60 to about 70° C., or about 65° C. In some embodiments, the solution is added into the mixture at a temperature of about 50° C. In some embodiments, the solution is added into the mixture at a temperature of about 60° C. In some embodiments, the solution is added into the mixture at a temperature of about 70° C. In some embodiments, the solution is added into the mixture at a temperature of about 80° C.

In some embodiments, a pH of the mixture is maintained in a range of about 7 to about 12 by adding the solution containing the one or more alkali metals. In some embodiments, the pH of the mixture is maintained in a range of about 7 to about 12, such as about 7.5 to about 11.5, about 8 to about 11, about 8.5 to about 10.5, about 9 to about 10, or about 8, about 9, about 10, about 11, or about 12.

In some embodiments, the method for preparing the catalyst further includes placing the sample in a water bath at a temperature of about 60 to about 90° C., such as about 65 to about 85° C., about 70 to about 80° C., or about 75° C. In some embodiments, the sample is placed in a water bath at a temperature of about 60° C. In some embodiments, the sample is placed in a water bath at a temperature of about 70° C. In some embodiments, the sample is placed in a water bath at a temperature of about 80° C. In some embodiments, the sample is placed in a water bath at a temperature of about 90° C.

In some embodiments, the method for preparing the catalyst further includes separating the precipitate from the mixture and washing with water to form a precursor product.

In some embodiments, the method for preparing the catalyst further includes calcining the precursor product in an oxygen-containing atmosphere at a temperature of about 250 to about 500° C. to form the catalyst. In some embodiments, the precursor product is calcined in an oxygen-containing atmosphere at a temperature of about 250 to about 500° C., such as about 280 to about 470° C., about 310 to about 440° C., about 340 to about 410° C., about 370 to about 380° C., or about 250° C., about 350° C., about 450° C., or about 500° C. In some embodiments, the precursor product is calcined in an oxygen-containing atmosphere at a temperature of about 350° C. In some embodiments, the precursor product is calcined in an oxygen-containing atmosphere at a temperature of about 400° C. In some embodiments, the precursor product is calcined in an oxygen-containing atmosphere at a temperature of about 450° C. In some embodiments, the oxygen-containing atmosphere is an air atmosphere.

### EXAMPLES

The following examples demonstrate methods for hydrogenating carbon dioxide (CO₂) as described herein. The examples are provided solely for illustration and are not to be construed as limitations of the present disclosure, as many variations thereof are possible without departing from the spirit and scope of the present disclosure.

### Example 1: General Procedure

The preparation of catalysts was done according to the described method below.

For example, a solution (Solution A) with a total metal salt concentration of 0.03 to 0.5 mol/L was prepared by dissolving an iron (Fe) salt in deionized water to afford an iron salt solution, followed by the addition of one or more salts of copper (Cu), zinc (Zn), and magnesium (Mg) to the iron salt solution. The mixture was stirred until it became clear, and the molar ratio of Fe to the combined metals (Cu, Zn, and Mg) was controlled within a range of about 2:1 to about 2:3.

One or more potassium (K) compounds were dissolved in water to prepare Solution B with a concentration of 0.2 to 1.2 mol/L.

Next, Solution B was added dropwise to Solution A under continuous stirring while maintaining the pH of the mixture between 7 and 12. The resulting mixture was aged at 50 to 80° C. for 12 hours during the co-precipitation process, resulting in the formation of a precipitated product.

The precipitated product was aged in a water bath at 60 to 90° C. for 12 to 24 hours. The aged precipitate was washed with deionized water, and the potassium content in the precipitate was adjusted to between 0.1 and 30%. The washed product was then dried to obtain a catalyst precursor.

The catalyst precursor was calcined in an air atmosphere at a temperature of 350 to 400° C. for 3 to 4 hours, resulting in the production of the finished catalysts.

### Example 2: Preparation of Potassium-Copper-Iron (K—CuFe) Catalyst

In accordance with the general procedure described in Example 1, Solution A was prepared using copper nitrate (Cu(NO₃)₂) and iron nitrate (Fe(NO₃)₂) in a molar ratio of Cu to Fe of 1:2. Solution B was prepared using potassium carbonate (K₂CO₃) and potassium hydroxide (KOH) in a molar ratio of K₂CO₃ to KOH of 1:5. Next, Solution B was added dropwise to Solution A under continuous stirring while maintaining the pH of the mixture between 7 and 12. The resulting mixture was aged at 50-80° C. for 12 hours to form a precipitate. The precipitate was filtered to obtain the precursor, which was subsequently dried at 60-90° C. and calcined in air at 350-400° C. for 3-4 hours.

### Example 3: Preparation of Potassium-Copper-Zinc-Iron (K—CuZnFe) Catalyst

In accordance with the general procedure described in Example 1, Solution A was prepared using Cu(NO₃)₂, zinc nitrate (Zn(NO₃)₂), and Fe(NO₃)₂ in a molar ratio of Cu to Zn to Fe of 2:1:4. Solution B was prepared using K₂CO₃ and KOH in a molar ratio of K₂CO₃ to KOH of 1:5. Next, Solution B was added dropwise to Solution A under continuous stirring while maintaining the pH of the mixture between 7 and 12. The resulting mixture was aged at 50-80° C. for 12 hours to form a precipitate. The precipitate was filtered to obtain the precursor, which was subsequently dried at 60-90° C. and calcined in air at 350-400° C. for 3-4 hours.

### Example 4: Preparation of Potassium-Copper-Magnesium-Iron (K—CuMgFe) Catalyst

In accordance with the general procedure described in Example 1, Solution A was prepared using Cu(NO₃)₂, magnesium nitrate (Mg(NO₃)₂), and Fe(NO₃)₂ in a molar ratio of Cu to Mg to Fe of 2:3:4. Solution B was prepared using K₂CO₃ and KOH in a molar ratio of K₂CO₃ to KOH of 1:5. Next, Solution B was added dropwise to Solution A under continuous stirring while maintaining the pH of the mixture between 7 and 12. The resulting mixture was aged at 50-80° C. for 12 hours to form a precipitate. The precipitate was filtered to obtain the precursor, which was subsequently dried at 60-90° C. and calcined in air at 350-400° C. for 3-4 hours.

### Example 5: Preparation of Potassium-Copper-Zinc-Magnesium-Iron (K—CuZnMgFe) Catalyst

In accordance with the general procedure described in Example 1, Solution A was prepared using Cu(NO₃)₂, Zn(NO₃)₂, Mg(NO₃)₂, and Fe(NO₃)₂ in a molar ratio of Cu to Zn to Mg to Fe of 2:1:3:4. Solution B was prepared using K₂CO₃ and KOH in a molar ratio of K₂CO₃ to KOH of 1:5. Next, Solution B was added dropwise to Solution A under continuous stirring while maintaining the pH of the mixture between 7 and 12. The resulting mixture was aged at 50-80° C. for 12 hours to form a precipitate. The precipitate was filtered to obtain the precursor, which was subsequently dried at 60-90° C. and calcined in air at 350-400° C. for 3-4 hours.

### Example 6: Inductively Coupled Plasma (ICP) Analysis

The composition of each component in the metal-catalysts from the above Examples 2-5 was determined by ICP spectroscopy and is presented in Table 1.

TABLE 1
Element content of four catalysts as characterized by ICP.

Element (wt %)

| Catalyst | K | Cu | Fe | Zn | Mg |
|---|---|---|---|---|---|
| K—CuFe | 9.98 | 20.01 | 32.67 | — | — |
| K—CuZnFe | 11.15 | 19.91 | 32.45 | 9.85 | — |
| K—CuMgFe | 10.40 | 14.94 | 24.05 | — | 5.71 |
| K—CuZnMgFe | 12.36 | 9.56 | 15.76 | 4.96 | 4.76 |

### Example 7: X-Ray Diffraction (XRD) Characterization of the Catalysts

FIG. 9 shows the XRD analysis result of the iron catalysts of Examples 2-5. The main compositions of the four catalysts, i.e., a K—CuFe catalyst, a K—CuZnFe catalyst, a K—CuMgFe catalyst, and a K—CuZnMgFe catalyst, are copper oxide (CuO) and iron (III) oxide (Fe₂O₃).

### Example 8: Morphology Characterization of the Catalysts

FIGS. 1A-1C, 2A-2C, 3A-3C, and 4A-4C show the scanning electron microscopy (SEM) images of the four catalysts, i.e., a K—CuFe catalyst, a K—CuZnFe catalyst, a K—CuMgFe catalyst, and a K—CuZnMgFe catalyst. In accordance with FIGS. 1A-4C, the iron catalysts contain particles of various sizes and shapes. The particle sizes are widely distributed, ranging from nanometers (nm) to micrometers (μm).

### Example 9: Catalytic Performance of the Catalysts in Carbon Dioxide (CO₂) Hydrogenation

The catalytic performance of the catalysts was evaluated in a custom-made fixed-bed reactor (with an inner diameter of 8 mm) using 400 mg of iron catalysts. Before measurement, the catalyst was reduced for 2 hours under a hydrogen flow rate of 20 mL/min at 350° C. After reduction, the feed gas with a ratio of H₂/CO₂/N₂ (where N₂ serves as an internal standard) of 72/24/4 was introduced into the reactor, which was then pressurized to 4 MPa. Subsequently, the gas flow rate was set to 20 mL/min. The downstream pipeline and valves of the reactor were maintained at 200° C. to prevent product condensation. The products were analyzed using a gas chromatograph with a thermal conductivity detector (TCD) and a flame ionization detector (FID). All data were obtained after 6 hours of reaction at the reaction temperature to ensure the equilibrium of the tail gas composition.

CO₂ conversion was calculated according to Equation (1).

$${CO}_{2} Conversion = \frac{{CO}_{2 i n} - {CO}_{2 out}}{{CO}_{2 i n}} \times 100 \% \qquad ( 1 )$$

where CO₂ in and CO₂ out stand for the moles of CO₂ at the inlet and outlet, respectively.

CO selectivity was calculated according to Equation (2).

$$CO Selectivity = \frac{{CO}_{out}}{{CO}_{2 i n} - {CO}_{2 out}} \times 100 \% \qquad ( 2 )$$

where CO out represents the mole of CO at the outlet.

Product (Ci) selectivity was calculated according to Equation (3).

$${C}_{i} selectivity = \frac{{C}_{i out} \times i}{{\sum }_{i = 1}^{n} {C}_{i out} \times i} \times 100 \% \qquad ( 3 )$$

where Cᵢ out represents the mole of Cᵢ at the outlet and i is the carbon number of product Cᵢ.

### Example 10: Catalytic Performance of K—CuFe Catalyst

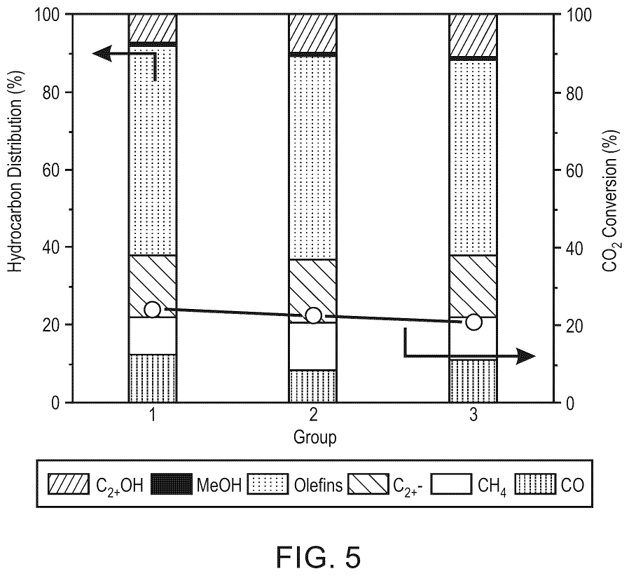

The catalytic performance of a K—CuFe catalyst in CO₂ hydrogenation was tested under the following reaction conditions: 4 MPa, 350° C., H₂/CO₂=3/1, WHSV=3000 mL·g_{cat}⁻¹·h⁻¹. The results were listed in Table 1 and FIG. 5.

TABLE 2
Performance of a K—CuFe catalyst in CO₂ hydrogenation

| | CO₂ | Product selectivity (%) | | | | | |
|---|---|---|---|---|---|---|---|
| Group | Conversion | CO | MeOH | C₂₊—OH | CH₄ | C₂₊— | Olefins |
| 1 | 24.13 | 12.30 | 0.51 | 7.27 | 9.75 | 15.84 | 54.19 |
| 2 | 22.35 | 8.40 | 0.56 | 9.99 | 12.27 | 16.26 | 52.35 |
| 3 | 20.70 | 11.05 | 0.57 | 10.86 | 11.26 | 15.58 | 50.50 |

A K—CuFe catalyst was prepared by coprecipitation and used for the reaction of CO₂ and H₂. Table 1 shows that at 350° C., the CO₂ conversion rate was about 24.13%, the olefin selectivity was about 54.19%, and the alcohol selectivity was about 7.78%.

### Example 11: Catalytic Performance of K—CuZnFe Catalyst

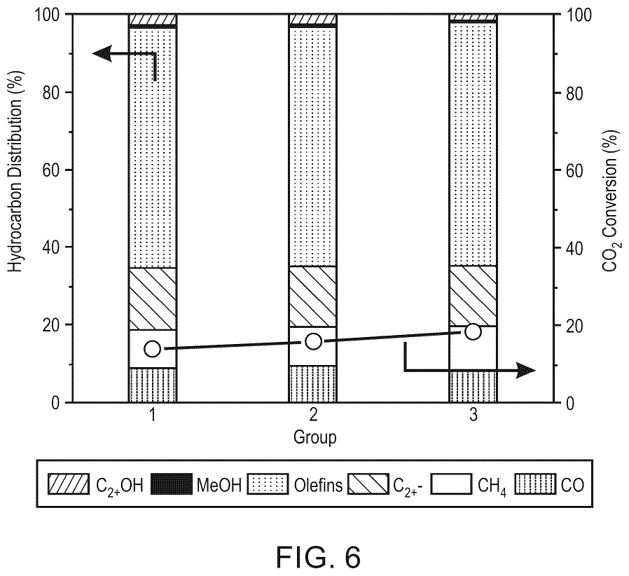

The catalytic performance of a K—CuZnFe catalyst in CO₂ hydrogenation was tested under the following reaction conditions: 4 MPa, 350° C., H₂/CO₂=3/1, WHSV=3000 mL·g_{cat}⁻¹·h⁻¹. The results were listed in Table 2 and FIG. 6.

TABLE 3
Performance of a K—CuZnFe catalyst in CO₂ hydrogenation

| | CO₂ | Product selectivity (%) | | | | | |
|---|---|---|---|---|---|---|---|
| Group | Conversion | CO | MeOH | C₂₊—OH | CH₄ | C₂₊— | Olefins |
| 1 | 14.03 | 9.17 | 0.66 | 2.85 | 9.75 | 16.02 | 61.55 |
| 2 | 15.89 | 9.83 | 0.55 | 2.68 | 9.85 | 15.62 | 61.48 |
| 3 | 18.44 | 8.66 | 0.36 | 1.67 | 11.33 | 15.37 | 62.61 |

A K—CuZnFe catalyst was prepared by coprecipitation and used for the reaction of CO₂ and H₂. Table 2 shows that at 350° C., the CO₂ conversion rate was about 18.44%, the olefin selectivity was about 62.61%, and the alcohol selectivity was about 2.03%. Compared to the K—CuFe catalyst, the incorporation of Zn into the catalyst promotes olefin formation.

### Example 12: Catalytic Performance of K—CuMgFe Catalyst

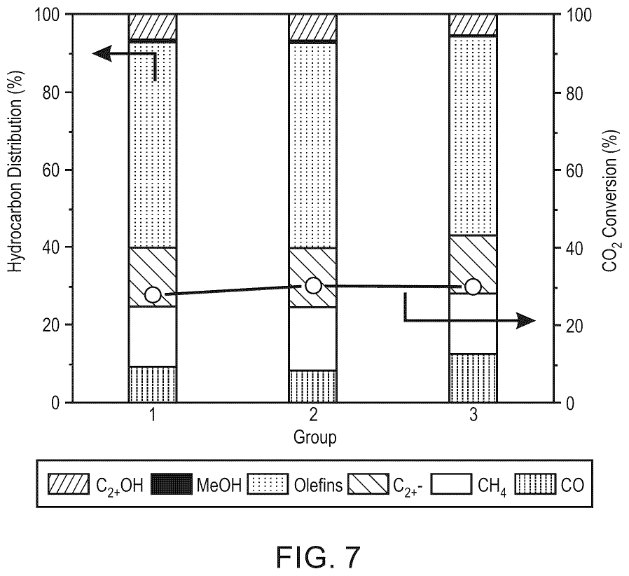

The catalytic performance of a K—CuMgFe catalyst in CO₂ hydrogenation was tested under the following reaction conditions: 4 MPa, 350° C., H₂/CO₂=3/1, WHSV=3000 mL·g_{cat}⁻¹·h⁻¹. The results were listed in Table 3 and FIG. 7.

TABLE 4
Performance of a K—CuMgFe catalyst in CO₂ hydrogenation

| | CO₂ | Product selectivity (%) | | | | | |
|---|---|---|---|---|---|---|---|
| Group | Conversion | CO | MeOH | C₂₊—OH | CH₄ | C₂₊— | Olefins |
| 1 | 27.74 | 9.30 | 0.71 | 6.61 | 15.43 | 15.15 | 52.79 |
| 2 | 30.19 | 8.37 | 0.28 | 6.96 | 16.35 | 15.20 | 52.84 |
| 3 | 29.83 | 12.59 | 0.15 | 5.48 | 15.59 | 14.92 | 51.27 |

A K—CuZnFe catalyst was prepared by coprecipitation and used for the reaction of CO₂ and H₂. Table 3 shows that at 350° C., the CO₂ conversion rate was about 30.19%, the olefin selectivity was about 52.84%, and the alcohol selectivity was about 7.24%.

### Example 13: Catalytic Performance of K—CuZnMgFe Catalyst

The catalytic performance of a K—CuZnMgFe catalyst in CO₂ hydrogenation was tested under the following reaction conditions: 4 MPa, 350° C., H₂/CO₂=3/1, WHSV=3000 mL·g_{cat}⁻¹·h⁻¹.

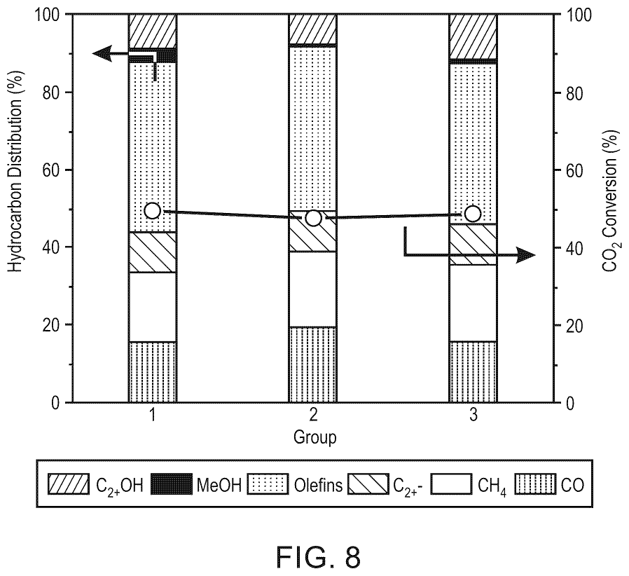

The results were listed in Table 4 and FIG. 8.

TABLE 5
Performance of a K—CuZnMgFe catalyst in CO₂ hydrogenation

| | CO₂ | Product selectivity (%) | | | | | |
|---|---|---|---|---|---|---|---|
| Group | Conversion | CO | MeOH | C₂₊—OH | CH₄ | C₂₊— | Olefins |
| 1 | 49.36 | 15.86 | 3.15 | 8.91 | 17.76 | 10.38 | 43.93 |
| 2 | 47.54 | 19.59 | 0.59 | 7.77 | 19.59 | 10.17 | 42.29 |
| 3 | 48.59 | 15.91 | 1.00 | 11.55 | 19.74 | 10.48 | 41.32 |

A K—CuZnMgFe catalyst was prepared by coprecipitation and used for the reaction of CO₂ and H₂. Table 4 shows that at 350° C., the CO₂ conversion rate was about 48.59%, the olefin selectivity was about 41.32%, and the alcohol selectivity was about 12.55%. K—CuZnMgFe catalysts demonstrate enhanced performance, including an increased CO₂ conversion rate and relatively improved selectivity for high-value-added products.

In general, the present disclosure describes catalysts that are capable of achieving direct one-step synthesis of alcohols co-producing olefins from CO₂ hydrogenation, addressing critical technical challenges. The catalysts can achieve a CO₂ conversion rate of, e.g., 48.59%, with alcohol selectivity reaching, e.g., 12.55%, and olefin selectivity as high as, e.g., 41.32%, demonstrating an efficient synergistic effect between its catalytic active components. Compared to reported CO₂ hydrogenation catalysts, the catalysts of the present disclosure exhibit superior performance, with about 50% CO₂ conversion and over 50% combined selectivity for valuable alcohols and olefins under mild reaction conditions, such as 350° C. and 4 MPa. The catalysts of the disclosure can also exhibit improved stability, showing no deactivation during long-term testing. Furthermore, the catalysts of the disclosure can address key challenges such as low CO₂ reactivity and selectivity due to side reactions, long-term stability issues like coke formation and phase changes in catalysts, and scalability from lab to industrial production. The use of common, cost-effective, and readily available divalent iron salts, copper salts, magnesium salts, and zinc salts can help ensure the catalyst's economic viability and sustainability. Prepared via the co-precipitation method, widely adopted in industrial processes, the catalyst's scalability was successfully demonstrated by producing it at a large scale as demonstrated in Examples 2-5. The catalysts of the present disclosure can help enable efficient and/or economically viable CO₂ hydrogenation processes with potentially substantial economic and/or social benefits.

While this specification contains certain implementation details, these should not be construed as limitations on the scope of what may be claimed, but rather as descriptions Features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

### Embodiments

Certain embodiments of this disclosure can be implemented as a catalyst for hydrogenating CO₂. A catalyst includes iron (Fe), one or more alkali metals selected from the group consisting of sodium (Na) and potassium (K), and one or more metals selected from the group consisting of copper (Cu), zinc (Zn), and magnesium (Mg). A molar ratio of the Fe to the one or more metals is from about 2:1 to about 2:3.

An aspect combinable with any other aspect can include the following features. The one or more alkali metals are present in the catalyst in an amount of from about 0.1 to about 30 wt. % based on a total weight of the catalyst.

An aspect combinable with any other aspect can include the following features. The catalyst includes particles having a particle size of from about 1 to about 80 nanometers (nm).

An aspect combinable with any other aspect can include the following features. The catalyst includes Fe, Cu, K, and one or more metals selected from the group consisting of Zn and Mg, and wherein a molar ratio of Cu to a total of the Fe and one or more metals is from about 1:2 to about 1:4.

An aspect combinable with any other aspect can include the following features. The catalyst includes Fe, Zn, K, and one or more metals selected from the group consisting of Cu and Mg, and wherein a molar ratio of Zn to a total of the Fe and one or more metals is from about 1:6 to about 1:9.

An aspect combinable with any other aspect can include the following features. The catalyst includes Fe, Mg, K, and one or more metals selected from the group consisting of Cu and Zn, and wherein a molar ratio of Mg to a total of the Fe and one or more metals is from about 1:2 to about 3:10.

An aspect combinable with any other aspect can include the following features. The catalyst is selected from the group consisting of a potassium-copper-iron (K—CuFe) catalyst, a potassium-copper-zinc-iron (K—CuZnFe) catalyst, a potassium-copper-magnesium-iron (K—CuMgFe) catalyst, and a potassium-copper-zinc-magnesium-iron (K—CuZnMgFe) catalyst.

An aspect combinable with any other aspect can include the following features. The catalyst includes from about 5 to about 30 wt. % Fe, from about 6 to about 25 wt. % K, from about 2 to about 20 wt. % Cu, from about 1 to about 10 wt. % Zn, from about 1 to about 10 wt. % Mg; and oxygen (O).

An aspect combinable with any other aspect can include the following features. The catalyst includes from about 13 to about 19 wt. % Fe, from about 10 to about 16 wt. % K, from about 7 to about 13 wt. % Cu, from about 3 to about 7 wt. % Zn, and from about 3 to about 7 wt. % Mg.

Certain embodiments of this disclosure can also be implemented as a method of hydrogenating carbon dioxide (CO₂) according to an aspect. The method includes introducing a hydrogen (H₂)-containing feed gas stream into a reactor containing the catalyst. The H₂-containing feed gas stream is passed through the reactor to contact the H₂-containing feed gas stream with the catalyst at a temperature of from about 200 to about 500° C. to form a reduced catalyst. The introducing the H₂-containing feed gas stream is terminated. A mixed feed gas stream comprising CO₂ and H₂ is introduced into the reactor. The mixed feed gas stream is passed through the reactor to contact the mixed feed gas stream with the reduced catalyst at a temperature of from about 150 to about 250° C. and a pressure of up to 8 megapascals (MPa) to form a gaseous product stream leaving the reactor. The gaseous product stream comprises a chemical reduction product of the CO₂.

An aspect combinable with any other aspect can include the following features. H₂ is present in the mixed feed gas stream at a concentration of about 40 to about 90 volume percentage (vol. %) based on a total volume of the mixed feed gas stream.

An aspect combinable with any other aspect can include the following features. CO₂ is present in the mixed feed gas stream at a concentration of from about 5 to about 45 vol. % based on the total volume of the mixed feed gas stream.

An aspect combinable with any other aspect can include the following features. A volume ratio of the H₂ to CO₂ in the mixed feed gas stream is from about 10:1 to 1:5.

An aspect combinable with any other aspect can include the following features. The H₂-containing feed gas stream further comprises an inert gas selected from the group consisting of nitrogen, argon, and helium.

An aspect combinable with any other aspect can include the following features. The mixed feed gas stream further includes an inert gas selected from the group consisting of nitrogen, argon, and helium.

An aspect combinable with any other aspect can include the following features. The reactor is at least one selected from the group consisting of a fixed-bed reactor, a trickle-bed reactor, a moving bed reactor, a rotating bed reactor, a fluidized bed reactor, and a slurry reactor.

An aspect combinable with any other aspect can include the following features. The H₂-containing feed gas stream is passed through the reactor at a flow rate of from about 10 to about 30 milliliters per minute (mL/min) at a temperature of about 350° C.

An aspect combinable with any other aspect can include the following features. The mixed feed gas stream is passed through the reactor at a flow rate of from about 10 to about 30 mL/min at a temperature of about 200° C. and under a pressure of about 4 MPa.

An aspect combinable with any other aspect can include the following features. The method has a CO₂ conversation rate of about 10 to about 60%.

An aspect combinable with any other aspect can include the following features. The gaseous product stream comprises from about 5 to about 25% of carbon monoxide (CO), from about 10 to about 50% of one or more paraffins, from about 0.5 to about 20% of one or more alcohols, and from about 30 to about 80% of one or more olefins, each wt. % based on a total weight of the gaseous product stream.

An aspect combinable with any other aspect can include the following features. The one or more paraffins include C1-C4 light paraffins, the one or more alcohols include methanol and ethanol, and the one or more olefins include C2-C4 light olefins.

Certain embodiments of this disclosure can be implemented as a method of making a catalyst according to an aspect by a process. The process includes mixing a Fe salt and one or more metal salts selected from the group consisting of a Cu salt, a Zn salt, and a Mg salt to form a mixture. A solution containing the one or more alkali metals is dropwise added into the mixture at a temperature of from about 50 to about 80° C. under continuous agitation to form a sample comprising a precipitate in the mixture. The sample is placed in a water bath at a temperature of from about 60 to about 90° C. The precipitate is separated from the mixture and washing with water to form a precursor product. The precursor product is calcined in an oxygen-containing atmosphere at a temperature of from about 250 to about 500° C. to form the catalyst.

An aspect combinable with any other aspect can include the following features. A total cation concentration of the Fe salt and the one or more metal salts present in the mixture is from about 0.03 to about 0.5 mol/L.

An aspect combinable with any other aspect can include the following features. The one or more alkali metal salts comprise sodium carbonate, sodium acetate, sodium sulfide, sodium bicarbonate, sodium hydroxide, potassium carbonate, potassium acetate, potassium sulfide, potassium bicarbonate, potassium hydroxide, or combinations thereof.

An aspect combinable with any other aspect can include the following features. A pH of the mixture is maintained from about 7 to about 12 by adding the solution comprising the one or more alkali metals.

1. A catalyst, comprising:
iron (Fe);
one or more alkali metals selected from the group consisting of sodium (Na) and potassium (K); and
one or more metals selected from the group consisting of copper (Cu), zinc (Zn), and magnesium (Mg);
wherein a molar ratio of the Fe to the one or more metals is from about 2:1 to about 2:3.

2. The catalyst of claim 1, wherein the one or more alkali metals are present in the catalyst in an amount of from about 0.1 to about 30 wt. % based on a total weight of the catalyst.

3. The catalyst of claim 1, wherein the catalyst comprises particles having a particle size of from about 1 to about 80 nanometers (nm).

4. The catalyst of claim 1, wherein the catalyst comprises Fe, Cu, K, and one or more metals selected from the group consisting of Zn and Mg, and wherein a molar ratio of Cu to a total of the Fe and one or more metals is from about 1:2 to about 1:4.

5. The catalyst of claim 1, wherein the catalyst comprises Fe, Zn, K, and one or more metals selected from the group consisting of Cu and Mg, and wherein a molar ratio of Zn to a total of the Fe and one or more metals is from about 1:6 to about 1:9.

6. The catalyst of claim 1, wherein the catalyst comprises Fe, Mg, K, and one or more metals selected from the group consisting of Cu and Zn, and wherein a molar ratio of Mg to a total of the Fe and one or more metals is from about 1:2 to about 3:10.

7. The catalyst of claim 1, wherein the catalyst is selected from the group consisting of a potassium-copper-iron (K—CuFe) catalyst, a potassium-copper-zinc-iron (K—CuZnFe) catalyst, a potassium-copper-magnesium-iron (K—CuMgFe) catalyst, and a potassium-copper-zinc-magnesium-iron (K—CuZnMgFe) catalyst.

8. The catalyst of claim 1, wherein the catalyst comprises:
from about 5 to about 30 wt. % Fe;
from about 6 to about 25 wt. % K;
from about 2 to about 20 wt. % Cu;
from about 1 to about 10 wt. % Zn;
from about 1 to about 10 wt. % Mg; and
oxygen (O).

9. The catalyst of claim 8, wherein the catalyst comprises:
from about 13 to about 19 wt. % Fe;
from about 10 to about 16 wt. % K;
from about 7 to about 13 wt. % Cu;
from about 3 to about 7 wt. % Zn; and
from about 3 to about 7 wt. % Mg.

10. A method of hydrogenating carbon dioxide (CO₂), comprising:
introducing a hydrogen (H₂)-containing feed gas stream into a reactor containing the catalyst of claim 1;
passing the H₂-containing feed gas stream through the reactor to contact the H₂-containing feed gas stream with the catalyst at a temperature of from about 200 to about 500° C. to form a reduced catalyst;
terminating the introducing the H₂-containing feed gas stream;
introducing a mixed feed gas stream comprising CO₂ and H₂ into the reactor; and
passing the mixed feed gas stream through the reactor to contact the mixed feed gas stream with the reduced catalyst at a temperature of from about 150 to about 250° C. and a pressure of up to 8 megapascals (MPa) to form a gaseous product stream leaving the reactor, wherein the gaseous product stream comprises a chemical reduction product of the CO₂.

11. The method of claim 10, wherein a volume ratio of the H₂ to CO₂ in the mixed feed gas stream is from about 10:1 to 1:5.

12. The method of claim 10, wherein the H₂-containing feed gas stream is passed through the reactor at a flow rate of from about 10 to about 30 milliliters per minute (mL/min) at a temperature of about 350° C.

13. The method of claim 10, wherein the mixed feed gas stream is passed through the reactor at a flow rate of from about 10 to about 30 mL/min at a temperature of about 200° C. and under a pressure of about 4 MPa.

14. The method of claim 10, wherein the method has a CO₂ conversation rate of about 10 to about 60%.

15. The method of claim 10, wherein the gaseous product stream comprises from about 5 to about 25% of carbon monoxide (CO), from about 10 to about 50% of one or more paraffins, from about 0.5 to about 20% of one or more alcohols, and from about 30 to about 80% of one or more olefins, each wt. % based on a total weight of the gaseous product stream.

16. The method of claim 15, wherein the one or more paraffins comprise C1-C4 light paraffins, the one or more alcohols comprise methanol and ethanol, and the one or more olefins comprise C2-C4 light olefins.

17. A method, comprising:
making a catalyst according to claim 1 by a process comprising:
mixing a Fe salt and one or more metal salts selected from the group consisting of a Cu salt, a Zn salt, and a Mg salt to form a mixture;
dropwise adding a solution comprising the one or more alkali metals into the mixture at a temperature of from about 50 to about 80° C. under continuous agitation to form a sample comprising a precipitate in the mixture;
placing the sample in a water bath at a temperature of from about 60 to about 90° C.;
separating the precipitate from the mixture and washing with water to form a precursor product; and
calcining the precursor product in an oxygen-containing atmosphere at a temperature of from about 250 to about 500° C. to form the catalyst.

18. The method of claim 17, wherein a total cation concentration of the Fe salt and the one or more metal salts present in the mixture is from about 0.03 to about 0.5 mol/L.

19. The method of claim 17, wherein the one or more alkali metal salts comprise sodium carbonate, sodium acetate, sodium sulfide, sodium bicarbonate, sodium hydroxide, potassium carbonate, potassium acetate, potassium sulfide, potassium bicarbonate, potassium hydroxide, or combinations thereof.

20. The method of claim 17, wherein a pH of the mixture is maintained from about 7 to about 12 by adding the solution comprising the one or more alkali metals.
